(19) United States
(12) Patent Application Publication
(10) Pub. No.: US 2006/0254309 A1
(43) Pub. Date: Nov. 16, 2006

(54) Fluid machine

(75) Inventors: Yasuhiro Takeuchi, Kariya-city (JP); Keiichi Uno, Kariya-city (JP); Shigeru Hisanaga, Kariya-city (JP); Hironori Asa, Okazaki-city (JP); Takashi Yamanaka, Kariya-city (JP); Atsushi Inaba, Kariya-city (JP); Kazuhide Uchida, Hamamatsu-city (JP); Hiroshi Ogawa, Nagoya-city (JP); Yoichiro Kawamoto, Nagoya-city (JP); Hiroshi Kishita, Anjo-city (JP)

Correspondence Address: POSZ LAW GROUP, PLC, 12040 SOUTH LAKES DRIVE, SUITE 101, RESTON, VA, 20191, US

(73) Assignees: DENSO CORPORATION, Kariya-city (JP); NIPPON SOKEN, INC., Nishio-city (JP)

(21) Appl. No.: 11/431,932

(22) Filed: May 11, 2006

(30) Foreign Application Priority Data
May 11, 2005 (JP) 2005-139111
Jun. 3, 2005 (JP) 2005-164037
Feb. 21, 2006 (JP) 2006-44420

(51) Int. Cl. F25B 23/00; F01C 1/00; F25B 1/00; F03C 2/00

(52) U.S. Cl. 62/501; 62/498; 62/467; 418/266

(57) ABSTRACT

A fluid machine has a scroll type expansion device which is operated by a high temperature high pressure refrigerant. The refrigerant is heated by use of waste heat from an engine for a vehicle. The fluid machine further has a motor generator for generating electric power when it is driven by a rotational force produced at the expansion device, wherein a rotating shaft of the motor generator is coupled to a movable scroll of the expansion device via a crank mechanism. A biasing member is provided for biasing the crank mechanism in a direction that the movable scroll wrap is separated from a contact in a circumferential direction with a fixed scroll wrap. Pressure of the refrigerant in a working chamber in the center portion is thereby equalized to the pressure in the outer peripheral portion, at a startup period of the expansion mode.

### CROSS REFERENCE TO RELATED APPLICATION

This application is based on Japanese Patent Application Nos. 2005-139111 filed on May 11, 2005, 2005-164037 filed on Jun. 3, 2005 and 2006-44420 filed on Feb. 21, 2006, the disclosures of which are incorporated herein by reference.

### FIELD OF THE INVENTION

The present invention relates to a heat cycle apparatus having a function of Rankine cycle.

The present invention further relates to a fluid machine including a scroll type expansion-compressor device having both functions of an expansion device and a compressor device, a motor generator also having both functions of an electric motor and an electric power generator. The fluid machine has a compression mode for compressing working fluid by driving the expansion-compressor device with the motor generator, and an electric power generating mode for generating electric power by driving the motor generator with the expansion-compressor device.

### BACKGROUND OF THE INVENTION

A fluid machine is known in the art, for example as disclosed in Japanese Patent Publication No.2005-30386. The fluid machine has an expansion device for converting heat energy of Rankine cycle Ra into a rotational force, a refrigerant pump driven by the rotational force and for increasing refrigerant pressure in the Rankine cycle, and an electric motor for generating a rotational driving force, wherein rotating shafts are commonly used for the respective components. In the fluid machine, the refrigerant is expanded by the scroll type expansion device having a crank mechanism so that the rotational force is obtained. The electric motor, which is coaxially arranged with the expansion device, is rotated by the rotational force to generate electric power.

In the above fluid machine, a start-up operation of the refrigerant pump is performed by the rotational driving force of the electric motor, when the Rankine cycle is started up. In this case, the expansion device starts with rotation in a condition that the refrigerant has not yet reached a sufficient high pressure. Namely, the expansion device is rotated in a condition that a high pressure refrigerant is not introduced into a working chamber formed by fixed and movable scroll wraps. This means that the expansion device is operated as if it is a vacuum pump. A useless load would be thereby applied to the electric motor, and it is a disadvantage that electric power consumption would be increased.

Accordingly, in the scroll type expansion device, it is designed such that the movable scroll wrap is separated from the fixed scroll wrap by an operation of the crank mechanism, when the pressure in the inner portion (the working chamber) of the scroll wraps becomes lower than the pressure in the outer portion of the scroll wraps. As a result, a pressure difference between the inner and outer portions is minimized, or the pressure in the inner portion is equalized with the pressure in the outer portion. However, during an intermediate period in which the pressure has not reached a predetermined pressure, a position of the movable scroll is not stable because of the operation of the crank mechanism, and thereby the movable scroll wrap may be repeatedly brought into contact or separated from the fixed scroll wrap.

This unstable movement of the movable scroll wrap continues until a high pressure refrigerant higher than a predetermined pressure is introduced to an inlet of the expansion device. As a result, a chattering of the movable scroll is caused, to thereby reduce lifetime of the expansion device due to a possible vibrating stress applied to the scroll wraps. Furthermore, the expansion device may be damaged or broken down.

A heat cycle apparatus is known in the art, for example, as disclosed in US Patent Application Publication No. 2004/0231331 A1. The heat cycle apparatus has a refrigerating cycle and Rankine cycle. In the refrigerating cycle, low pressure refrigerant is evaporated to absorb heat from a low temperature side, and evaporated refrigerant is compressed to increase the temperature thereof and the heat absorbed from the low temperature side is radiated to a high temperature side. In the Rankine cycle, the heat energy contained in the fluid (the refrigerant) is converted into kinetic energy.

In the above prior art (No. 2004/0231331 A1), the heat cycle apparatus is disclosed, which comprises an expansion-compressor device having a function of an expansion device operated in the Rankine cycle, in addition to a compressor device for the refrigerating cycle. The heat cycle apparatus is applied to an automotive gas compression refrigerating apparatus.

The heat cycle apparatus of this prior art has a structure shown in FIG. 5 of this application. In the case that it is operated as the refrigerating cycle, a three way valve 18 is switched over to a bypass position (indicated by a dotted line) for bypassing a heating device 15, an ON-OFF valve 7 is opened, and an expansion-compressor device 2 is driven by a driving force from an engine 1 so that it is operated as the compressor device.

The heating device 15 is a heat exchanger for heating the refrigerant by heat-exchange between engine cooling water (hot water) and the refrigerant. When the three way valve 18 is switched over to the bypass position, the engine cooling water does not pass through the heating device 15, and thereby the refrigerant is not heated at the heating device 15.

Therefore, the high pressure refrigerant pumped out from the expansion-compress or device 2 is circulated in the refrigerating cycle without being heated at the heating device 15, wherein the refrigerating cycle comprises the expansion-compressor device 2, a heat radiating device (condenser) 8, a gas-liquid separator 10, an expansion valve 13, and an evaporator 14.

In the case that the heat cycle apparatus is operated as the Rankine cycle, the three way valve 18 is switched over to a hot water circulation position (indicated by a solid line) for supplying the engine cooling water to the heating device 15, the ON-OFF valve 7 is closed, and an electrically driven refrigerant pump 12 is operated for pumping out the refrigerant.

When the refrigerant pump 12 is operated, liquid-phase refrigerant is supplied from the gas-liquid separator 10 to the heating device 15, because the ON-OFF valve 7 is closed. Further, when the three way valve 18 is switched over to the hot water circulation position, the engine cooling water (hot water) passes through the heating device 15, so that the refrigerant is heated at the heating device 15 to vaporized high pressure refrigetant.

The high pressure refrigerant is introduced into the expansion-compressor device 2 from its refrigerant inlet port and flows out from a refrigerant outlet port, wherein the refrigerant is expanded in the expansion-compressor device 2. The refrigerant is accordingly circulated in the Rankine cycle, which comprises the refrigerant pump 12, the heating device 15, the expansion-compressor device 2, a second bypass passage 20, the heat radiating device 8, the gas-liquid separator 10, and a first bypass passage 11.

The expansion-compressor device 2 is operated as the expansion device, when the high pressure refrigerant is expanded in the expansion-compressor device 2. Thus, the kinetic energy for driving an electric power generator is obtained in the Rankine cycle.

A control for the heat cycle apparatus during a period, in which the heat cycle apparatus is not operated, is not disclosed in the above prior art. Generally, the three way valve 18 is switched over to the hot water circulation position and the ON-OFF valve 7 is opened, when the heat cycle apparatus is not operated.

The reason why the three way valve 18 is switched over to the hot water circulation position is that the engine cooling water is supplied to the heating device 15 even during the period of non-operation of the heat cycle apparatus, so long as the engine 1 is running. As a result, the heating device 15 (the refrigerant therein) is kept heated, and thereby a time for heating the heating device 15 is shortened at a start-up operation of the heat cycle apparatus. The time for heating the heating device 15 may become longer depending on heat capacity of the heating device. The reason is, therefore, to improve a start-up performance.

The reason why the ON-OFF valve 7 is opened is that there is formed a closed space defined by refrigerant passages connecting the refrigerant pump 12 to the expansion-compressor device 15 through the heating device 15 if the ON-OFF valve 7 is closed, and the refrigerant in the closed space is heated by the heating device 15 to become abnormally high pressure refrigerant.

For example, in the case that Freon gas (R134a) is used as the refrigerant, pressure of saturated vapor of the Freon gas at 100° C. is higher than 4 PAa. The temperature of the engine cooling water may become even more than 100° C., depending on an operating condition of the engine. Accordingly, the pressure in the closed space may be pressurized at a value higher than 4 PAa.

Because of the above reason, the ON-OFF valve 7 is opened during the period of non-operation of the heat cycle apparatus, in order that the refrigerant pressure in the heat cycle may not be pressurized to an abnormally high value.

However, when the ON-OFF valve 7 is opened during the period of non-operation of the heat cycle apparatus, the refrigerant pressure in the space (the space defined by refrigerant passages connecting the refrigerant pump 12 to the expansion-compressor device 15 through the heating device 15) can not be kept at a high value (not at abnormally high but a necessary high value). Accordingly, when an operation of the Rankine cycle is started up, the expansion-compressor device 2 can not immediately output the kinetic energy during the start-up period from a time point of starting the operation of the refrigerant pump 12 to a time point at which the refrigerant from the refrigerant pump 12 is heated at the heating device 15 and vaporized to the high pressure refrigerant. As above, the start-up performance of the prior art Rankine cycle is not sufficiently high.

### SUMMARY OF THE INVENTION

The present invention is made in view of the foregoing problems, and has an object to provide a fluid machine for collecting waste heat from an automotive engine by Rankine cycle to generate electric power. In the fluid machine, a useless consumption of driving force (electric power) is reduced at a start-up operation of the Rankine cycle (an operation of the electric power generation mode), and thereby amount of the collected energy is increased. Furthermore, a quiet operation of the fluid machine is achieved during a transit period from the start-up to a stable operation.

According to a feature of the invention, a fluid machine has a housing (111) for accommodating an expansion device (110); a shaft (1181) rotationally supported by the housing (111) and having a driving pin (1181a) at one axial end of the shaft (1181), the driving pin (1181a) being eccentric to a rotating center of the shaft (1181); a bushing (1182) having a hole (1182a) for receiving therein the driving pin (1181a); a movable scroll (113) having a base plate (113a) provided with a boss portion for rotatably receiving the bushing (1182), the movable scroll (113) further having a vortical movable scroll wrap (113b); a fixed scroll (112) fixed to the housing (111) and having a base plate (112a) and a vortical fixed scroll wrap (112b) to be engaged with the vortical movable scroll wrap (113b); and a motor generator (120) coupled to and operated with the shaft (1181). In the fluid machine, a biasing member (160) is provided for biasing the crank mechanism (118) in a direction that the movable scroll wrap (113b) is separated from a contact in a circumferential direction with the fixed scroll wrap (112b).

According to another feature of the invention, a fluid machine has a housing (111) for accommodating an expansion device (110); a shaft (1181) rotationally supported by the housing (111) and having a driving pin (1181a) at one axial end of the shaft (1181), the driving pin (1181a) being eccentric to a rotating center of the shaft (1181); a movable scroll (113) having a base plate (113a) provided with a boss portion for rotatably receiving the driving pin (1181a), the movable scroll (113) further having a vortical movable scroll wrap (113b), wherein the movable scroll (113) is operatively coupled with the shaft (1181) via the driving pin (118a) and the boss portion, so that the movable scroll (113) is rotated around the shaft (1181). The fluid machine further has a fixed scroll (112) fixed to the housing (111) and having a base plate (112a) and a vortical fixed scroll wrap (112b) to be engaged with the vortical movable scroll wrap (113b); and a motor generator (120) coupled to and operated with the shaft (1181). In the fluid machine, a first clearance portion (C-1) is provided on at least one of the movable and fixed scroll wraps (113b, 112b) at a center portion thereof to form a first clearance between them, a second clearance portion (C-2) is provided on at least one of the movable and fixed scroll wraps (113b, 112b) at an outer portion thereof to form a second clearance between them, and a phase angle of a non-clearance portion formed between the first and second clearance portions (C-1, C-2) is less than 360 degrees, and a bypass mechanism (170) is provided for communicating the center portion with a working chamber (V) reaching its minimum volume.

According to a further feature of the invention, a fluid machine has a housing (111) for accommodating an expansion device (110); a shaft (1181) rotationally supported by the housing (111) and having a driving pin (118la) atone axial end of the shaft (1181), the driving pin (1181a) being eccentric to a rotating center of the shaft (1181); a movable scroll (113) having a base plate (113a) provided with a boss portion for rotatably receiving the driving pin (1181a), the movable scroll (113) further having a vortical movable scroll wrap (113b), wherein the movable scroll (113) is operatively coupled with the shaft (1181) via the driving pin (1181a) and the boss portion, so that the movable scroll (113) is rotated around the shaft (1181). The fluid machine further has a fixed scroll (112) fixed to the housing (111) and having a base plate (112a) and a vortical fixed scroll wrap (112b) to be engaged with the vortical movable scroll wrap (113b); and a motor generator (120) coupled to and operated with the shaft (1181). In the fluid machine, a clutch device (180) is provided between the motor generator (120) and the shaft (1181) for selectively connecting the motor generator (120) with the shaft (1181).

It is another object of the invention to provide a heat cycle apparatus having Rankine cycle, in which refrigerant pressure in the cycle is prevented from abnormally increasing to a high pressure and a start-up performance is increased.

According to a feature of the invention, a heat cycle apparatus has Rankine cycle for converting heat energy contained in refrigerant into kinetic energy; a refrigerant pump for pumping out the refrigerant; an expansion device for producing kinetic energy by expansion of the refrigerant from the refrigerant pump; a refrigerant pipe for connecting the refrigerant pump with the expansion device; a heating device for heating the refrigerant in the refrigerant pipe; and a pressure maintaining device for maintaining the pressure of the refrigerant in the refrigerant pipe when the Rankine cycle is not in its operation. In the above heat cycle apparatus, the pressure maintaining device releases a part of the refrigerant from the refrigerant pipe to a low pressure portion at which the pressure of the refrigerant is lower than that of the refrigerant in the refrigerant pipe, when the pressure of the refrigerant in the refrigerant pipe becomes higher than a predetermined value.

### BRIEF DESCRIPTION OF THE DRAWINGS

The above and other objects, features and advantages of the present invention will become more apparent from the following detailed description made with reference to the accompanying drawing. In the drawing:

FIG. 1 is a schematic cross sectional view of a fluid machine according to a first embodiment of the present invention;

FIG. 2 is a schematic system structure of a refrigerating apparatus, to which the fluid machine of FIG. 1 is applied;

FIG. 3A is a schematic oblique view showing a crank mechanism incorporated into the fluid machine of FIG. 1;

FIG. 3B is a schematic cross sectional view showing a part of the crank mechanism shown in FIG. 3A;

FIG. 3C is a schematic cross sectional view taken along a line IIIC-IIIC in FIG. 3B;

FIG. 4A is a schematic oblique view showing a modification of the crank mechanism, which can be incorporated into the fluid machine of FIG. 1;

FIG. 4B is a schematic oblique view showing a portion (bushing) of the modified crank mechanism shown in FIG. 4A, when viewed in a direction “IVB”;

FIG. 4C is a schematic cross sectional view showing a part of the crank mechanism shown in FIG. 4A;

FIG. 5A is a schematic oblique view showing a crank mechanism according to a second embodiment of the present invention;

FIG. 5B is a schematic cross sectional view showing a part of the crank mechanism shown in FIG. 5A;

FIG. 6A is a schematic oblique view showing a modification of the crank mechanism according to the second embodiment;

FIG. 6B is a schematic cross sectional view showing a part of the crank mechanism shown in FIG. 6A;

FIG. 6C is a schematic cross sectional view taken along a line IVC-IVC in FIG. 6B;

FIG. 7A is an explanatory view showing a relative position of scroll wraps according to a third embodiment;

FIG. 7B is a schematic cross sectional view taken along a line VIIB-VIIB in FIG. 7A;

FIG. 8 is a schematic cross sectional view of a fluid machine according to a fourth embodiment;

FIG. 9 is a schematic system structure of a refrigerating apparatus according to a fifth embodiment;

FIG. 10 is a schematic cross sectional view of a fluid machine according to the fifth embodiment;

FIG. 11 is a schematic structure of a gas compression refrigerating apparatus for a vehicle according to a sixth embodiment of the present invention;

FIG. 12 is a schematic structure of a gas compression refrigerating apparatus for a vehicle according to a seventh embodiment;

FIG. 13 is a schematic structure of a gas compression refrigerating apparatus for a vehicle according to an eighth embodiment;

FIG. 14 is a schematic structure of a gas compression refrigerating apparatus for a vehicle according to a ninth embodiment; and

FIG. 15 is a schematic structure of a gas compression refrigerating apparatus of a related art.

### DETAILED DESCRIPTION OF THE PREFERRED EMBODIMENTS

### First Embodiment

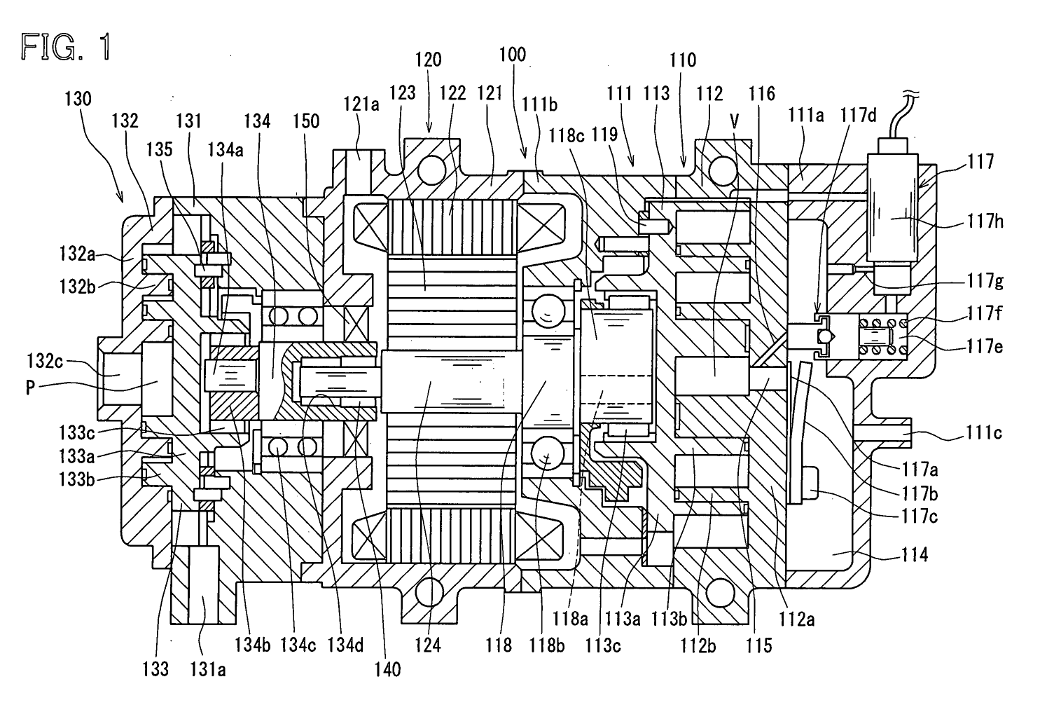

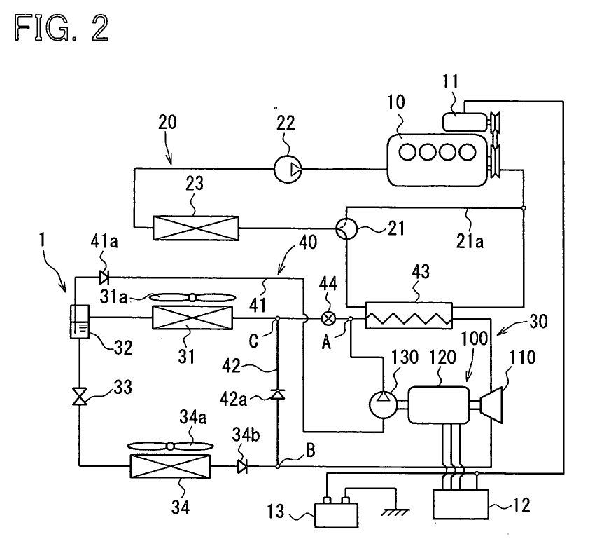

Embodiments of the present invention will be explained with reference to the drawings. FIG. 1 is a cross sectional view showing a complex fluid machine 100 (in which a compressor device, an expansion device and a refrigerant pump are integrally formed into one unit), whereas FIG. 2 is a schematic diagram showing a refrigerating apparatus to which the fluid machine 100 of the present invention is applied. According to the embodiments of the present invention, the fluid machine 100 is applied to a refrigerating apparatus 1 for an automotive vehicle, which has a refrigerating cycle 30 and Rankine cycle 40.

At first, a structure of the complex fluid machine 100 will be explained with reference to FIG. 1. The complex fluid machine 100 comprises an expansion-compressor device 110 having both functions of a compressor device and an expansion device, a motor generator 120 having both functions of an electric power generator and an electric motor, and a refrigerant pump 130.

The expansion-compressor device 110 has the same structure to a well-known scroll type compressor, and comprises a compressor housing 111 for the expansion-compressor device 110, which is composed of a front housing 111a, a shaft housing 111b, and a fixed scroll 112 provided between the front and shaft housings 111a and 111b. The expansion-compressor device 110 further comprises a movable scroll 113 facing to and rotated with respect to the fixed scroll 112, a discharge port 115 for communicating a working chamber V with a high pressure chamber 114, an inlet port 116, and a valve device 117 for opening and closing the inlet port 116.

The fixed scroll 112 has a base plate 112a and a vortical scroll wrap 112b extending from the base plate 112a toward the movable scroll 113, whereas the movable scroll 113 has a vortical scroll wrap 113b to be contacted and engaged with the vortical scroll wrap 112b and a base plate 113a on which the scroll wrap 113b is formed. The working chamber V is formed between the fixed scroll 112 and the movable scroll 113, the scroll wraps 112b and 113b of which are operatively contacted with each other. The volume of the working chamber V is changed (expanded or contracted) when the movable scroll 113 is rotated with respect to the fixed scroll 112 (moves around the fixed scroll).

A shaft 118 is a crank shaft, which is rotationally supported by a bearing 118b fixed to the shaft housing 111b, and which has a crank portion 118a at its one axial end, wherein the crank portion 118a is eccentric with respect to a rotational center of the shaft 118. A bushing 118c is provided at the crank portion 118a, wherein the bushing 118c is rotatable with respect to the crank portion 118a, and the bushing 118c is connected to the movable scroll 113 via a bearing 113c.

A self rotation prevention mechanism 119 is provided between the movable scroll 113 and the shaft housing 111b, so that the movable scroll 113 rotates around the crank portion 118a by one turn when the shaft 118 is rotated by one turn. Namely, the movable scroll 113 is prevented from rotating on its axis but is rotated around the rotational center of the shaft 118 (in an orbital motion). The volume of the working chamber V becomes smaller, as the working chamber is moved from the outside portion of the movable scroll 113 toward its center, when the shaft 118 is rotated in a forward direction On the other hand, the volume of the working chamber V becomes larger, as the working chamber is moved from its center toward the outside portion of the movable scroll 113, when the shaft 118 is rotated in a reversed direction.

The discharge port 115 is formed at a center portion of the base plate 112a, so that the working chamber V, which has become to its minimum volume when the expansion-compressor device 110 is operated as the compressor device (hereinafter, referred to as a compression mode), is communicated with the high pressure chamber 114 formed in the front housing 111a to discharge (pump out) the compressed refrigerant (the compressed working fluid).

The inlet port 116 is likewise formed in the base plate 112a (adjacent to the discharge port 115), to communicate the high pressure chamber 114 with the working chamber V, which has become to its minimum volume when the expansion-compressor device 110 is operated as the expansion device (hereinafter, referred to as an expansion mode), so that high pressure and high temperature refrigerant (i.e. superheated vaporized refrigerant=gas phase working fluid) supplied into the high pressure chamber 114 is introduced into the working chamber V.

The high pressure chamber 114 has a function for smoothing pulsation of the refrigerant pumped out from the discharge port 115, and a high pressure port 111c to be connected to a heating device 43 and a condenser 31 is formed at the high pressure chamber 114.

A low pressure port 121a, which is connected to an evaporator 34 and a second bypass passage 42, is formed in a motor housing 121. The low pressure port 121a is communicated with a low pressure side (an outer peripheral portion) of the fixed and movable scrolls 112 and 113 of the expansion-compressor device 110, through the inside of the motor housing 121.

The valve device 117 comprises a discharge port valve device having a discharge valve 117a, an inlet port valve device having a valve body 117d, an electromagnetic valve 117h, and so on. The discharge valve 117a is arranged in the high pressure chamber 114, and is a check valve of a reed valve shape for preventing the refrigerant pumped out from the discharge port 115 from flowing back from the high pressure chamber 114 into the working chamber V. A stopper 117b is a valve stopping plate for restricting a maximum opening degree of the discharge valve 117a. The discharge valve 117a and the stopper 117b are fixed to the base plate 112a by a bolt 117c.

The valve body 117d is a switching valve for switching from the compression mode to the expansion mode, and vice versa, by opening or closing the inlet port 116. A backward portion of the valve body 117d is slidably inserted into a back pressure chamber 117e formed in the front housing 111a. A spring 117f (a biasing means) is disposed in the inside of the back pressure chamber 117e, for biasing the valve body 117d in a valve closing direction, namely in a direction in which a forward portion of the valve body 117d closes the inlet port 116.

An orifice 117g is formed in the front housing 111a, at a passage connecting the back pressure chamber 117e with the high pressure chamber 114, wherein the orifice 117g has a certain flow resistance.

A ball is provided between the forward portion and the backward portion of the valve body 117d, in order that the forward portion can be inclined with respect to the backward portion. Accordingly, a seal performance for closing the inlet port 116 by the valve body 117d is increased.

The electromagnetic valve 117h is a control valve for controlling the pressure in the back pressure chamber 117e, by controlling a communication condition between the low pressure side (the low pressure port 121a) and the back pressure chamber 117e. The control valve 117h is operated by an electronic control unit (not shown).

When the electromagnetic valve 117h is opened, the pressure in the back pressure chamber 117e is decreased to become lower than that in the high pressure chamber 114. The valve body 117d is moved in the right hand side of FIG. 1, compressing the spring 117f, to open the inlet port 116. The pressure loss at the orifice 117g is extremely high, and thereby the flow amount of the refrigerant from the high pressure chamber 114 into the back pressure chamber 117e is negligible small.

When the electromagnetic valve 117h is closed, the pressure in the back pressure chamber 117e becomes equal to that of the high pressure chamber 114 through the orifice 117g. Then, the valve body 117d is moved in the left hand direction in FIG. 1 by the spring force of the spring 117f, to close the inlet port 116. As above, the valve body 117d, the back pressure chamber 117e, the spring 117f, the orifice 117g, and the electromagnetic valve 117h form an electrical switching valve of a pilot type, to open and close the inlet port 116.

The motor generator 120 comprises a stator 122 and a rotor 123 rotating in the inside of the stator 122, and is accommodated in the motor housing 121 (in the low pressure space of the fluid machine 100) fixed to the shaft housing 111b. The stator 122 is a stator coil wound with electric wires and is fixed to an inner peripheral surface of the motor housing 121.

The rotor 123 is a magnet rotor, in which permanent magnets are provided, and is fixed to a motor shaft 124. One end of the motor shaft 124 is connected to the shaft 118 of the expansion-compressor device 110, and the other end is formed into a small diameter portion, which is operatively connected to a pump shaft 134 for the refrigerant pump 130, as described below.

The motor generator 120 is operated as a motor (the electric motor) for driving the expansion-compressor device 110 (operating as the compressor device), when electric power is supplied from a battery 13 to the stator 122 through an inverter 12 and thereby the rotor 123 is rotated (in the forward direction). The motor generator 120 is also operated as the motor (the electric motor), for driving the refrigerant pump 130, when the rotor 123 is rotated (in the reversed direction), as described below.

The motor generator 120 is furthermore operated as a generator (an electric power generator) for generating electric power, when a torque for rotating the rotor 123 (in the reversed direction) is inputted by a driving force produced by the expansion-compressor device 110 in its expansion mode. The electric power thus obtained is charged into the battery 13 through the inverter 12.

The refrigerant pump 130 is arranged at an adjacent position to the motor generator 120, and at the opposite side of the expansion-compressor device 110, and accommodated in the pump housing 131 fixed to the motor housing 121.

The refrigerant pump 130 comprises, as in the same manner to the expansion-compressor device 110, a fixed scroll 132 having a base plate 132a and a scroll wrap 132b, and a movable scroll 133 having a base plate 133a and a scroll wrap 133b.

The fixed scroll 132 is fixed to a pump housing 131, whereas the movable scroll 133 is arranged in a space defined by the pump housing 131 and the fixed scroll 132. The movable scroll 133 rotates in an orbital motion, and a self rotation on its axis is prevented by a self rotation preventing mechanism 135.

A pump inlet port 131a is provided at the pump housing 131. The pump inlet port 131a is connected to a gas-liquid separator 32 (explained below) and communicated with the inside space of the pump housing 131 on a side of the movable scroll 133. A pump outlet port 132c is provided at the fixed scroll 132, wherein the pump outlet port 132c is communicated with a working chamber P formed by the fixed and movable scrolls 132, 133, and connected to a heating device 43 (explained below).

The pump shaft 134 is rotationally supported by a bearing 134c fixed to the pump housing 131, and has a crank portion 134a at its one axial end, wherein the crank portion 134a is eccentric with respect to a rotational center of the pump shaft 134. The crank portion 134a is connected to the movable scroll 133 via a bushing 134b and a bearing 133c. The other end of the pump shaft 134 is operatively connected to the other end of the motor shaft 124. Namely, the other axial end of the pump shaft 134 is formed with a hole portion 134d, into which the small diameter portion of the motor shaft 124 is inserted.

A one way clutch 140 is provided between the motor shaft 124 and the pump shaft 134. The one way clutch 140 is brought into the engagement when the motor shaft 124 is rotated in the reversed direction, so that the motor shaft 124 is brought into the engagement with the pump shaft 134 to rotate the same. On the other hand, the one way clutch 140 becomes out of engagement from the pump shaft 134, when the motor shaft 124 is rotated in the forward direction, to disconnect the pump shaft 134 from the motor shaft 124 (not to rotate the pump shaft 134).

A shaft seal member 150 is provided between the motor housing 121 and the pump shaft 134, to seal the inner space of the motor generator 120 from the refrigerant pump 130 (the low pressure side space communicating the pump inlet port 131a with the movable scroll 133). The fluid machine 100, as described above, is incorporated into the refrigerating cycle 30 having the Rankine cycle 40, to form the refrigerating apparatus 1.

More specifically, the expansion-compressor device 110 (working as the compressor in a compression mode) is incorporated into the refrigerating cycle, whereas the expansion-compressor device 110 (working as the expansion device in an expansion mode) and the refrigerant pump 130 are incorporated into the Rankine cycle 40. The refrigerating apparatus 1 will be explained with reference to FIG. 2.

The refrigerating cycle 30 transfers the heat from a low temperature side to a high temperature side, and utilizes its cold heat and hot heat for an air conditioning operation. The refrigerating cycle 30 comprises the expansion-compressor device 110, a condenser 31, a gas-liquid separator 32, a depressurizing device 33, the evaporator 34 and so on, in which those components are connected in a closed fluid circuit.

The condenser 31 is a heat exchanger connected at a refrigerant discharge side of the expansion-compressor device 110 in the case of the compression mode, and for cooling down the high pressure and high temperature refrigerant to condense (liquidize) the refrigerant. A condenser fan 31a blows cooling air (outside air) toward the condenser,31.

The gas-liquid separator 32 is a receiver for separating the refrigerant condensed at the condenser 31 into a gas-phase refrigerant and a liquid-phase refrigerant, to flow out the liquid-phase refrigerant. The depressurizing device 33 is a temperature dependent type expansion valve for depressurizing and expanding the liquid-phase refrigerant separated at the gas-liquid separator 32, wherein an opening degree of the valve is controlled so that the refrigerant is depressurized in an isenthalpic manner and that superheated degree of the refrigerant to be sucked into the expansion-compressor device 110 in the compression mode is controlled at a predetermined value.

The evaporator 34 is a heat exchanger for performing a heat absorbing operation by evaporating the refrigerant depressurized by the depressurizing device 33, to cool down air outside of a vehicle (the outside air) or air inside of the vehicle (the inside air), which is blown through the evaporator by a blower fan 34a. A check valve 34b is provided at a refrigerant outlet side of the evaporator 34, for allowing the refrigerant to flow only from the evaporator 34 to the expansion-compressor device 110.

The Rankine cycle 40 collects energy (a driving force at the expansion mode of the expansion-compressor device 110) from waste heat generated at an engine 10 producing a driving power for the vehicle. The condenser 31 is commonly used in both of the refrigerating cycle 30 and the Rankine cycle 40.

A first bypass passage 41 is provided between the gas-liquid separator 32 and a juncture A, which is an intermediate point between the condenser 31 and the expansion-compressor device 110, wherein the first bypass passage 41 bypasses the condenser 31. A second bypass passage 42 is provided between junctures B and C, wherein the juncture B is an intermediate point between the expansion-compressor device 110 and the check valve 34b, whereas the juncture C is an intermediate point between the condenser 31 and the juncture A.

The refrigerant pump 130 of the complex fluid machine 100 and a check valve 41a are arranged in the first bypass passage 41, wherein the check valve 41a allows the refrigerant to flow only from the gas-liquid separator 32 to the refrigerant pump 130. The heating device 43 is provided between the juncture A and the expansion-compressor device 110.

The heating device 43 is a heat exchanger for heating the refrigerant by heat-exchange between the refrigerant supplied by the refrigerant pump 130 and engine cooling water (hot water) of an engine cooling circuit 20 (hot water circuit) of the engine 10. A three way valve 21 is provided in the hot water circuit 20. A heating device bypass passage 21a is provided between the three way valve 21 and the engine 10. The three way valve 21 switches from a hot water circulation mode to a water non-circulation mode (a hot water bypass mode), and vice versa, so that the hot water from the engine 10 is controlled to be supplied or not to be supplied to the heating device 43. A switching operation of the three way valve 21 is controlled by an electronic control unit (not shown).

An alternator 11 is provided at the engine 10, wherein the alternator 11 is driven by the engine 10, and the electric power generated at the alternator 11 is charged into a battery 13 through an inverter 12.

A water pump 22, which is, for example, a mechanical pump driven by the engine 10 or an electrical pump driven by an electric motor, is provided in the hot water circuit 20 for circulating the engine cooling water, and a radiator 23 is a heat exchanger for heat-exchanging the engine cooling water with the outside air for cooling down the engine cooling water.

A check valve 42a is provided in the second bypass passage 42 for allowing the refrigerant to flow only from the expansion-compressor device 110 to an inlet side of the condenser 31. An ON-OFF valve 44 is provided in a passage between the junctures A and C. The ON-OFF valve 44 is an electromagnetic valve for opening or closing the passage and is controlled by the electronic control unit (not shown).

As above, the Rankine cycle 40 is formed by the gas-liquid separator 32, the first bypass passage 41, the refrigerant pump 130, the heating device 43, the expansion-compressor device 110, the second bypass passage 42, the condenser 31, and so on.

An operation of the complex fluid machine 100 according to the above embodiment will be explained below.

(Compression Mode)

In the compression mode, the motor generator 120 is operated as the electric motor when a cooling operation by the refrigerating cycle is necessary. A rotational force is applied to the motor shaft 124 (in the forward direction) to rotate the movable scroll 113 of the expansion-compressor device 110, so that the refrigerant is sucked and compressed in the refrigerating cycle.

More specifically, the ON-OFF valve 44 is opened by the control unit (not shown) and the engine cooling water is prevented by the three way valve 21 from flowing into the heating device 43. The electromagnetic valve 117h is closed to close the inlet port 116 by the valve body 117d, and the electric power is supplied to the stator 122 of the motor generator 120 from the battery 13 through the inverter 12 to rotate the motor shaft 124.

During this operation, as in the same manner to the well known scroll type compressor, the expansion-compressor device 110 sucks the refrigerant from the low pressure port 121a, compresses the same in the working chamber V, pumps out the compressed refrigerant from the discharge port 115 into the high pressure chamber 114, and discharges the compressed refrigerant from the high pressure port 111c to the condenser 31.

The refrigerant discharged from the high pressure port 111c is circulated in the refrigerating cycle 30 of the heating device 43, the ON-OFF valve 44, the condenser 31, the gas-liquid separator 32, depressurizing device 33, the evaporator 34, the check valve 34b, the low pressure port 121a of the expansion-compressor device 110, so that the cooling operation is performed by the heat absorbing operation at the evaporator 34.

Since the engine cooling water (the hot water) does not flow into the heating device 43, the refrigerant is not heated in the heating device 43, and thereby the heating device 43 operates simply as a part of the refrigerant passage.

Since the pump shaft 134 for the refrigerant pump 130 becomes out of the engagement from the motor shaft 124 because of the one way clutch 140, the refrigerant pump 130 is not operated in this mode, namely refrigerant pump 130 does not act as operating resistance.

(Expansion Mode: Electric Power Generating Mode)

In the expansion mode, the high pressure super heated refrigerant heated by the heating device 43 is supplied into the expansion-compressor device 110 to expand the refrigerant in the expansion device 110, when the cooling operation by the refrigerating cycle 30 is not necessary and when a sufficient waste heat can be obtained from the engine 10 (when the temperature of the engine cooling water is sufficiently high). The movable scroll 113 is rotated by the expansion of the refrigerant to obtain a driving force (mechanical energy) for rotating the motor shaft 124. The rotor 123 of the motor generator 120 is rotated by thus obtained driving force, to generate the electric power, and to charge the generated electric power into the battery 13.

A start-up operation of the conventional Rankine cycle 40 will be explained. The refrigerant pump 130 is at first driven by the motor generator 120, which is operated as the electric motor. In this operation, the expansion-compressor device 110 is also driven by the operation of the motor generator 120, so that a vacuum pimping operation is produced in the expansion-compressor device 110. Then, the valve device 117 is controlled to switch over the operational mode of the expansion-compressor device 110 from the compression mode to the expansion mode. The operation for the motor generator 120 in a vector control mode is started, wherein a rotational position of the rotor 123 is detected and the electric current to the stator 122 is controlled in a feed-back manner to rotate the rotor 123. When a refrigerant pressure at the inlet port 116 is increased to become higher than a predetermined value, the motor generator 120 starts its electric power generation.

More specifically, the ON-OFF valve 44 is closed by the control unit (not shown) and the engine cooling water is circulated by the three way valve 21 to flow into the heating device 43. The motor generator 120 is operated as the electric power generator (rotation in the reversed direction) and the electromagnetic valve 117h is opened to open the inlet port 116 by the valve body 117d.

In this operation, the pump shaft 134 of the refrigerant pump 130 is brought into the engagement with the motor shaft 124 through the one way clutch 140, so that the refrigerant pump 130 is driven to rotate. The high pressure super heated refrigerant heated by the heating device 43 is supplied into the working chamber V through the high pressure port 111c, the high pressure chamber 114, and the inlet port 116, so that the refrigerant is expanded in the working chamber V.

The movable scroll 113 is rotated by the expansion of the refrigerant in the reversed direction opposite to that in the compression mode, the rotational driving force applied to the shaft 118 is transmitted to the motor shaft 124 and the rotor 123 of the motor generator 120. When the driving force transmitted to the motor shaft 124 becomes higher than a driving force necessary for the refrigerant pump 130, the motor generator starts its rotation as the electric power generator. And the obtained electric power is charged into the battery 13 through the inverter 12.

The refrigerant, the pressure of which is decreased as a result of the expansion, flows out from the low pressure port 121a. The refrigerant flowing out from the low pressure port 121a is circulated in the Rankine cycle 40, which comprises the second bypass passage 42, the check valve 42a, the condenser 31, the gas-liquid separator 32, the first bypass passage 41, the check valve 41a, the refrigerant pump 130, the heating device 43 and the expansion-compressor device 110 (the high pressure port 111c). The refrigerant pump 130 supplies the liquid-phase refrigerant from the gas-liquid separator 32 to the heating device 43, wherein the refrigerant is pressurized to such a pressure corresponding to the temperature of the superheated vaporized refrigerant produced at the heating device 43.

In the case that the refrigerant pump 130 is separately provided from the fluid machine 110, in which the expansion-compressor device 110 and the motor generator 120 are integrally formed, the refrigerant pump 130 is operated at first and then the expansion-compressor device 110 is forcibly driven by the motor generator 120 by its motor function. In this operation, the electric power is supplied to the stator 122, without detecting the rotational position of the rotor 123 to forcibly drive the same. The vacuum pimping operation is produced in the expansion-compressor device 110. Then, the valve device 117 is controlled to switch over the operational mode of the expansion-compressor device 110 from the compression mode to the expansion mode. When the motor generator 120 is rotated at a speed higher than a predetermined speed (e.g. 1,000 rpm), the operation for the motor generator 120 in a vector control mode is started. When a refrigerant pressure at the inlet port 116 is increased to become higher than a predetermined value, the motor generator 120 starts its electric power generation.

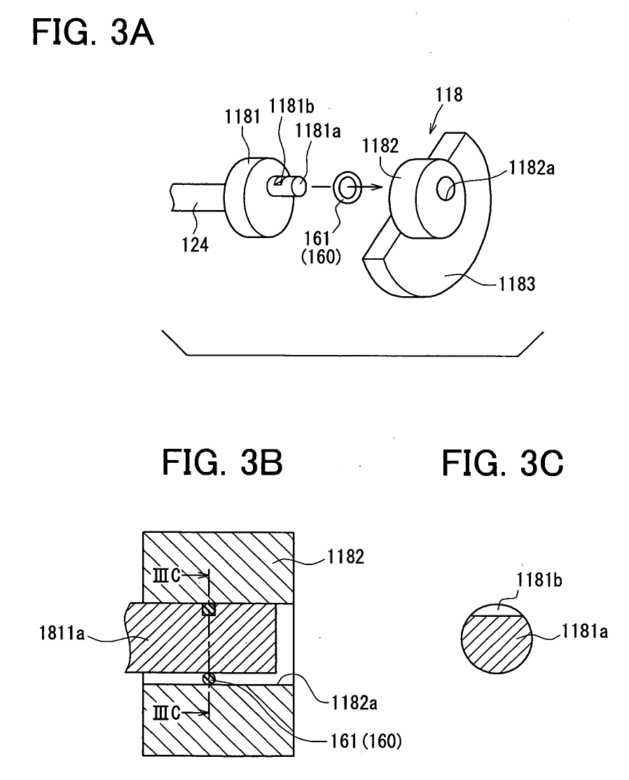

A characteristic portion of the present invention will be explained. FIGS. 3A to 3C show a crank mechanism 118 of a swing-ring type, wherein FIG. 3A is an oblique view, FIG. 3B is a cross sectional view showing a driving pin 1181a and a bushing 1182, and FIG. 3C is a cross sectional view taken along a line IIIC-IIIC of FIG. 3B. An operation of the swing-ring type crank mechanism 118 is well known, and therefore its detailed explanation is omitted here.

The driving pin 1181a is provided at one end of a shaft 1181, wherein the driving pin 1181a is eccentric to an axis of the shaft 1181. The driving pin 1181a is inserted into a hole 1182a formed in the bushing 1182, wherein the driving pin 1181a slides within the hole in a circumferential direction. The bushing 1182 is operatively coupled to the movable scroll 113, namely it is inserted into a space formed in a boss portion of the movable scroll 113. The shaft 1181 is integrally formed with the motor shaft 124, and a balancing weight 1183 is integrally formed with the bushing 1182.

An elastic member 160, such as an O-ring 161 made of rubber, is provided on an outer peripheral surface of the driving pin 1181a, wherein the elastic member 160 operates as a biasing means for biasing the movable scroll 113 in such a direction that the scroll wraps 112b and 113b are separated from the contact in a circumferential direction. A notch 1181b is formed at such a position of the driving pin 1181a, that a biasing force (elastic force) of the O-ring 161 is applied to the movable scroll 113 only in the direction that the scroll wraps 112b and 113b are separated from the contact.

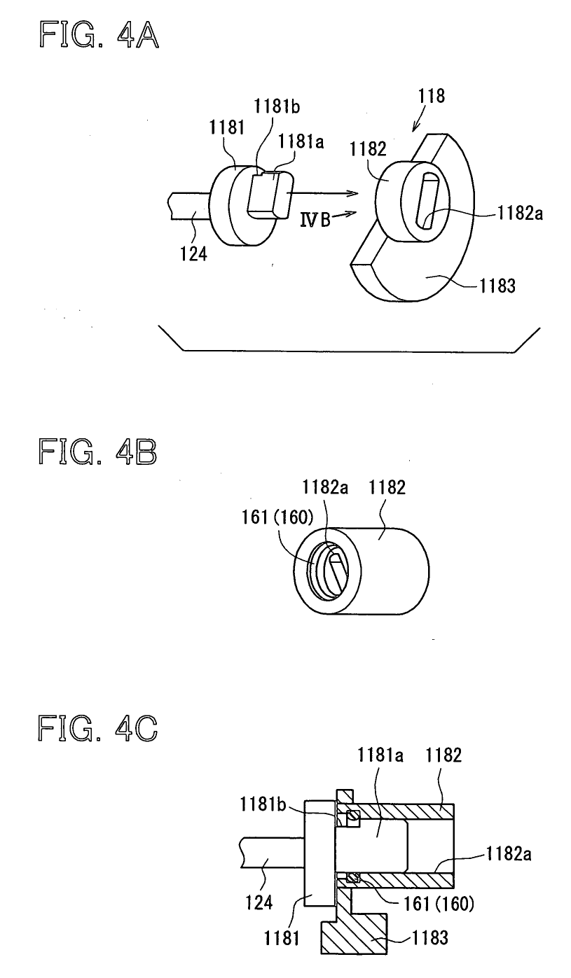

FIGS. 4A to 4C show a modification of the crank mechanism of a slider type, wherein FIG. 4A is an oblique view, FIG. 4B is an oblique view of the bushing 1182 when viewed in a direction of an arrow VIB in FIG. 4A, and FIG. 4C is a cross sectional view of the crank mechanism wherein the driving pin 1181a is inserted into the hole 1182a of the bushing 1182. This crank mechanism 118 of the slider type is different from that of the swing-ring type shown in FIG. 3 in that the driving pin 1181a is formed into a key shape having two flat surface portions parallel to each other, whereas the hole 1182a of the bushing 1182 is formed with two flat surface portions parallel to each other, so that the driving pin 1181a is inserted into the hole 1182a in a sliding manner. The bushing 1182 can slide along the flat surface portion which is in contact with the flat surface portion of the driving pin 1181a, in a direction of the contact.

The elastic member 160, such as the O-ring 161 made of rubber, is provided in a circular groove formed in an inside of the bushing 1182. As shown in FIG. 4C, the elastic member 160 is arranged on the outer surface of the driving pin 1181a when the driving pin 1181a is inserted into the hole 1182a, so that the elastic member 160 biases the movable scroll 113 in the direction that the scroll wraps 112b and 113b are separated from the contact. A notch 1181b is also formed at such a position of the driving pin 1181a, that the biasing force (elastic force) of the O-ring 161 is applied to the movable scroll 113 only in the direction that the scroll wraps 112b and 113b are separated from the contact. In other words, the O-ring 161 is not compressed at the notch 1181b, and the elastic force is thereby not applied to the movable scroll 113. In the crank mechanism of FIG. 3, the O-ring 161 is provided on the outer peripheral surface of the driving pin 1181a before it is assembled, whereas the O-ring 161 is provided in the circular groove of the inside surface of the bushing 1182 in the crank mechanism of FIG. 4. It is apparent that the O-ring 161 can be provided on either side of the driving pin 1181a and the bushing 1182.

According to the above embodiment, the elastic member (the biasing means) 160 is provided in the crank mechanism 118 in order to bias the movable scroll 113 in the direction that the movable scroll wrap 113a is separated from the fixed scroll wrap 112a. The pressure in the working chamber V in the center portion is thereby equalized to the pressure in the outer peripheral portion, at a start up period of the expansion mode (electric power generating mode). As a result, it is not necessary to use the unproductive driving power (electric power), so that the amount of the collected energy can be accordingly increased.

Furthermore, chattering of the movable scroll 113 can be suppressed even on a half way to a predetermined pressure, because the movable scroll 113 is stably held by the bias means 160 at the non-contact position with the fixed scroll 112 so that the movement of the movable scroll 113 is prevented from repeatedly coming into contact with and coming out of contact with the fixed scroll 112. In the conventional system, it is necessary to design the motor generator 120 having a larger rotational torque in consideration of the vacuum pump operation at the start up period of the expansion mode (electric power generating mode). However, according to the present invention, the motor generator 120 can be designed to be smaller.

The elastic member 160 is provided between the driving pin 1181a and the bushing 1182 as the biasing means. This means that the biasing means can be provided easily and in a simple manner, so that the cost increase can be prevented. As described before, the biasing means 160 (the O-ring 161) can be provided on either side of the driving pin 1181a and the bushing 1182.

### Second Embodiment

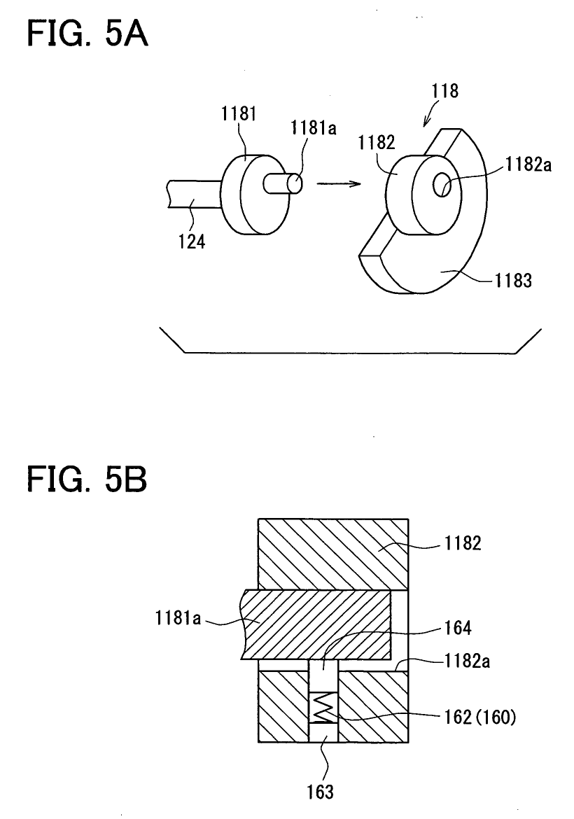

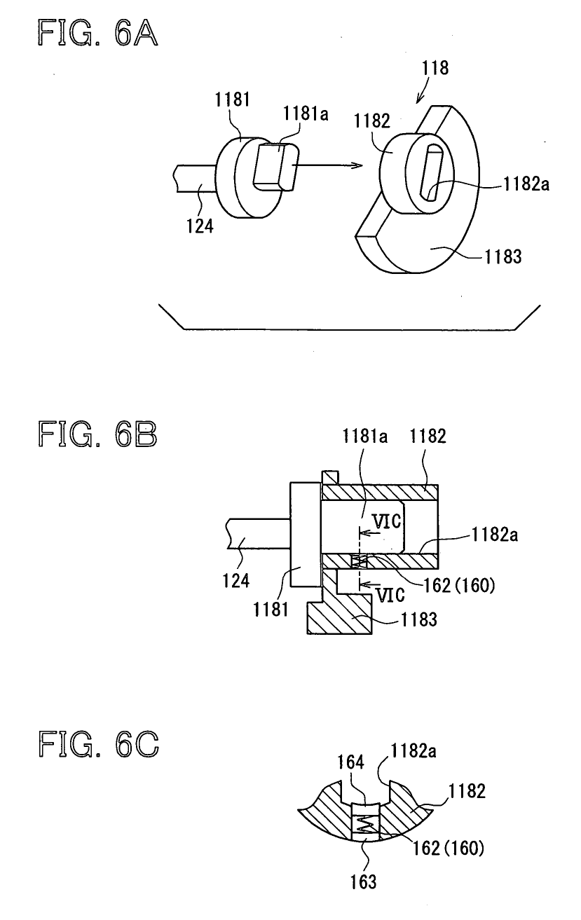

FIGS. 5A and 5B show a second embodiment for the crank mechanism 118 of the swing-ring type, wherein FIG. 5A is an oblique view, and FIG. 5B is a cross sectional view showing the driving pin 1181a and the bushing 1182. FIGS. 6A to 6C show the second embodiment for the crank mechanism 118 of the slider type, wherein FIG. 6A is an oblique view, FIG. 6B is a cross sectional view showing the driving pin 1181a and the bushing 1182, and FIG. 6C is a cross sectional view taken along a line VIC-VIC of FIG. 6B.

The second embodiment shown in FIGS. 5A-5B and FIGS. 6A-6C is different from the crank mechanism 118 shown in FIGS. 3A-3B and FIGS. 4A-4C, in that a spring 162 is provided in the bushing 1182, as the biasing means 160, in order to bias the movable scroll 113 in the direction that the movable scroll wraps 113b is separated from the contact with the fixed scroll wrap 112b. In FIG. 5B, a numeral 163 designates a spring stopper, and a numeral 164 designates a sliding member for keeping a smooth sliding operation between the driving pin 1181a and the sliding member 164. The biasing means 160 can be provided on the side of the driving pin 1181a.

As above, the biasing means 160 is made of the spring 162, and it is easier to select the spring having an appropriate biasing (spring) force and size. The cost for the spring is not high, either. The spring stopper 163 is provided in order that one end of the spring 162 is held by the spring stopper 163, and the position of the spring 162 is likewise held by the spring stopper 163.

The sliding member 164 is provided between the driving pin 1181a and the spring 162. In case of the crank mechanism 118 of the slider type, the spring 162 may be directly contacted with the driving pin 1181a. In case of the crank mechanism 118 of the swing-ring type, it is more preferable to provide the sliding member 164 since the driving pin 1181a slides with respect to the bushing 1182. Durability is increased by the sliding member 164.

### Third Embodiment

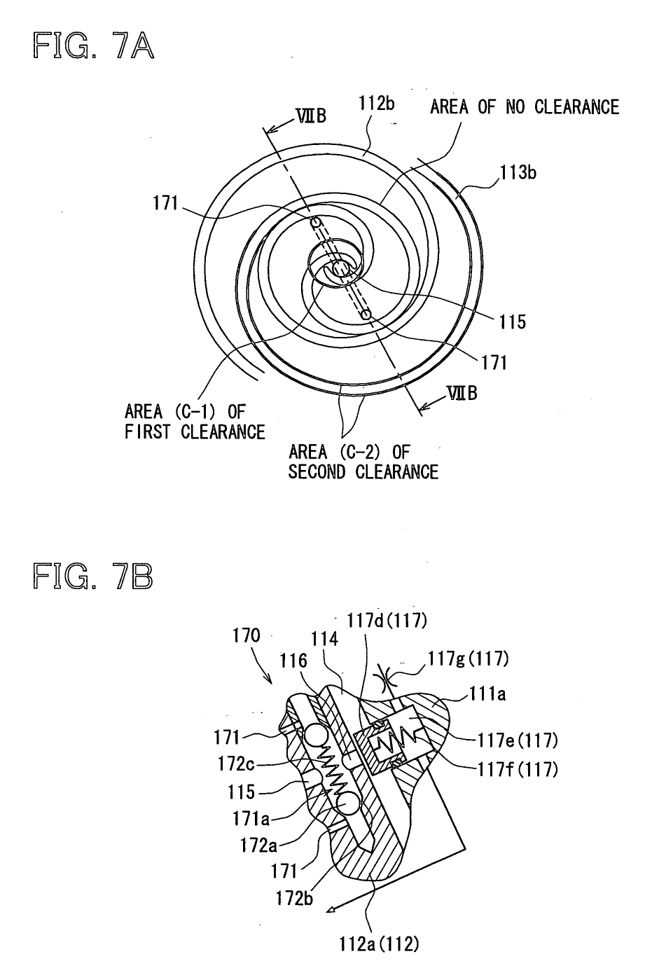

FIGS. 7A and 7B show a bypass mechanism 170 according to a third embodiment of the present invention. FIG. 7A is an explanatory drawing showing relative positions of the movable and fixed scrolls and bypass holes 171. FIG. 7B is an enlarged cross sectional view taken along a line VIIB-VIIB in FIG. 7A. A clearance is formed between the movable and fixed scroll wraps 112b and 113b, so that both scroll wraps 112b and 113b may not be brought into contact with each other at more than two points in an angular range of larger than 360°. The bypass holes 171 are provided in the base plate 112a of the fixed scroll 112 for operatively communicating the bypass holes 171 with the discharge port 115.

More specifically, the bypass holes 171 are opened to the working chamber(s) V reaching its minimum volume as shown in FIG. 7A, and the bypass holes 171 are communicated with the discharge port 115 by a bypass passage 171a through check valves 172. As shown in FIG. 7B, each of the check valves 172 has a ball 172a to be seated on a valve seat 172b formed in the bypass passage 171a. A spring 172c is disposed in the bypass passage 171a for biasing the balls 172a towards the valve seats 172b.

The inlet port 116 is formed in the base plate 112a of the fixed scroll 112 such that it is opened to the bypass passage 171a at the opposite side of the discharge port 115. The valve device 117 similar to the first embodiment (FIG. 1) is provided in the front housing 111a such that the valve device 117 faces to the inlet port 116.

According to the above structure of the bypass holes 171, the check valves 172, the discharge port 115, the inlet port 116 and the valve device 117, the refrigerant in the working chamber V is released through the check valves 172 to the discharge port 115 when the refrigerant pressure in the working chamber V becomes higher than a predetermined value. As a result, the pressure in the working chamber can be equalized with the pressure in the discharge port 115.

According to the above structure, the expansion device is prevented from working as the vacuum pump at the start up operation of the Rankine cycle.

As is also shown in FIG. 7A, first and second clearance portions C-1, C-2 are provided on the movable scroll wrap 113b. More specifically, the first clearance portion C-1 is provided on the movable scroll wrap 113b at its center portion to form a first clearance between the fixed and movable scroll wraps 112b and 113b, whereas the second clearance portion C-2 is provided on the movable scroll wrap 113b at its outer portion to form a second clearance between the fixed and movable scroll wraps 112b and 113b. The second clearance portion C-2 is indicated by heavy lines in FIG. 7A. As seen from FIG. 7A, the second clearance portion C-2 is formed on the inner and outer peripheral surfaces of the movable scroll wrap 113b at the outer portion thereof. Furthermore, as seen from FIG. 7A, a non-clearance portion is formed on the movable scroll wrap 113b between the first and second clearance portions C-1, C-2, wherein a phase angle of such non-clearance portion is less than 360°.

As described above, a clearance is generally formed between the movable and fixed scroll wraps for the scroll type compressor, so that both scroll wraps may not be brought into contact with each other at more than two points in an angular range of larger than 360°. This is because a large bending moment is applied to radix portions of the scroll wraps at a certain relative position thereof, if the scroll type compressor is designed such that scroll wraps are brought into contact with each other at more than two points on one side surface. In such a case, the scroll wraps may be deformed or damaged. When the clearance is formed, the contacts of the scroll wraps at two points can be avoided. And the chattering of the scroll wraps, which may be generated if the scroll wraps are brought into contact with each other at more than two points on one side surface, can be suppressed. Accordingly, the scroll wraps having more than one turn are designed such that they are brought into contact with each other at one point on one side surface (two points on both side surfaces).

This is also applied to the design for the expansion device. Namely, in the present invention, an attention is paid to the fact that the clearance has a bypassing function. At the outer portion of the scrolls, which is the low pressure portion of the compressor device, the refrigerant can move from one working chamber V to the other working chamber V through the clearance. It is, therefore, not necessary to provide a specific bypass passage at the outer portion of the scrolls. At the inner portion of the scrolls, which is the high pressure portion of the compressor device, the bypass passage 171a is provided between the discharge port 115 (formed at the center of the scroll) and the bypass holes 171 so that the working chamber V (at its minimum volume) is communicated with the discharge port 115. Thus, the over expansion of the refrigerant is prevented and the driving force for the vacuum pump is decreased.

As above, the bypass mechanism 170 makes it possible to reduce a pressure difference between the pressure of the working chamber V at the center portion and the pressure of the working chamber V at the outer portion of the scrolls, at the start up period of the electric power generation mode. As a result, it is possible to decrease the amount of the unproductive driving power (electric power), so that the amount of the collected energy can be accordingly increased. In the conventional system, it is necessary to design the motor generator 120 having a larger running torque in consideration of the vacuum pump operation at the start up period of the electric power generation mode. According to the above embodiment of the present invention, the motor generator 120 can be designed smaller. Furthermore, since the bypass mechanism 170 can be designed smaller, the cost increase can be also suppressed.

In the above embodiment, the bypass mechanism 170 is constructed by the check valves 172, which do not require any electric control. Accordingly, the bypass mechanism 170 can be easily manufactured at a lower cost.

### Fourth Embodiment

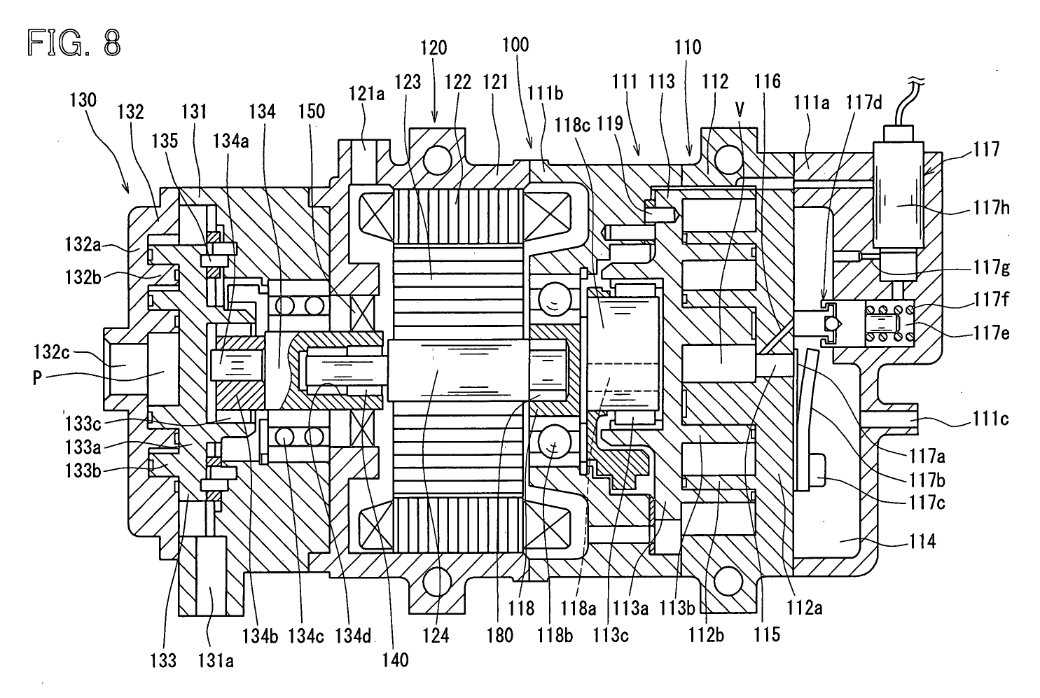

FIG. 8 is a cross sectional view of a fluid machine 100 according to a fourth embodiment, which differs from the first embodiment (FIG. 1) in that a clutch 180 is provided between the expansion-compressor device 110 and the motor generator 120, more specifically, between the shaft 118 and the motor shaft 124.

The motor generator 120 is disconnected from the expansion-compressor device 110 by the clutch 180 until the refrigerant pressure reaches the predetermined high pressure. The vacuum pump operation by the expansion-compressor device 110 is avoided at the start up period of the Rankine cycle 40. Accordingly, it is not necessary to use the unproductive driving power (electric power), so that the amount of the collected energy can be accordingly increased. At the same time, the generation of the chattering of scroll wraps can be prevented.

As in the same manner to the third embodiment, the motor generator 120 can be designed smaller. The clutch 180 may be constructed by a one way clutch, an electromagnetic clutch and so on.

In the embodiment shown in FIG. 8, the one way clutch 180 is provided. The clutch 180 is engaged when the motor generator 120 is rotated in a direction to operate the expansion-compressor device 110 as the compressor device, or when the expansion-compressor device 110 is operated as the expansion device to transmit the rotational force from the shaft 118 to the motor shaft 124. The clutch 180 is disengaged when the motor shaft 124 is rotated in a direction, in which the expansion-compressor device 110 is rotated to expand the working chamber V.

### Fifth Embodiment

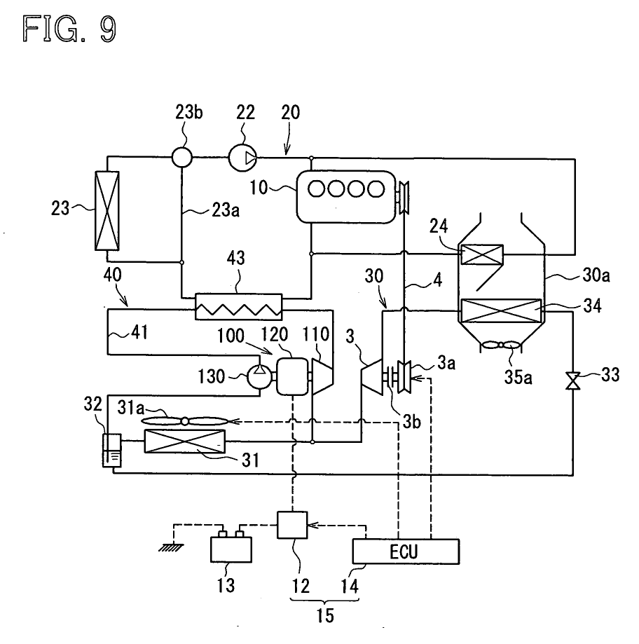

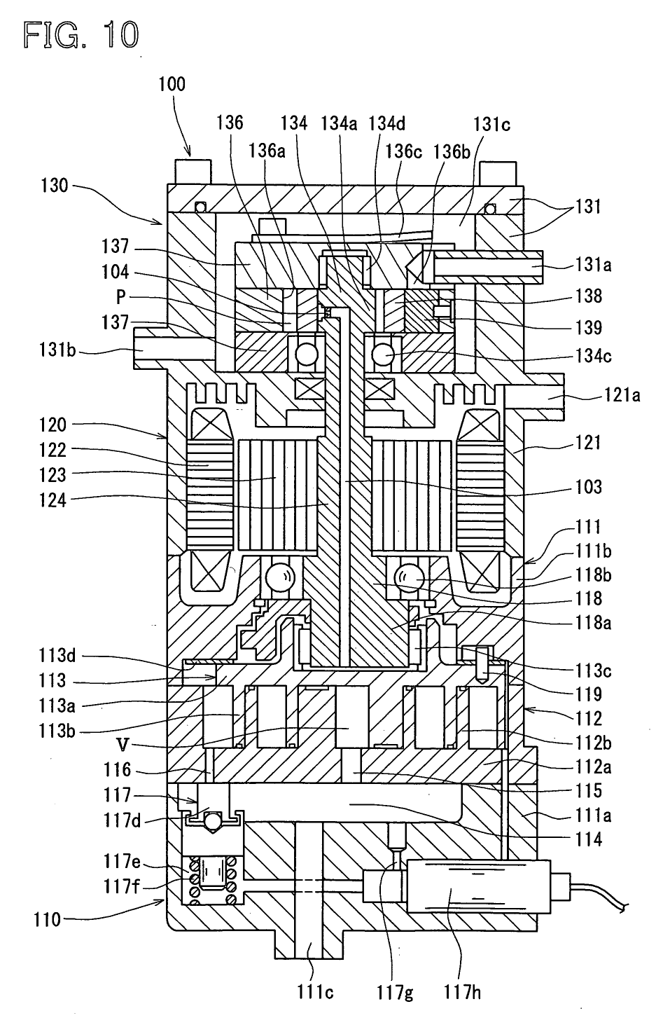

FIG. 9 is a schematic diagram showing a refrigerating apparatus according to a fifth embodiment, in which the fluid machine 100 is incorporated. FIG. 10 is a cross sectional view of the fluid machine 100 according to the fifth embodiment.

The fluid machine 100 is provided in Rankine cycle 40, in which a condenser 31 and a gas-liquid separator 32 are commonly used for the automotive refrigerating cycle 30 and the Rankine cycle 40.

The fluid machine 100 integrally has an expansion device 110, a motor generator 120 and a refrigerant pump 130. A system structure will be explained below with reference to FIG. 9. The refrigerating cycle 30 transfers the heat from a low temperature side to a high temperature side, and utilizes its cold heat and hot heat for an air conditioning operation. The refrigerating cycle 30 comprises a compressor device 3, the condenser 31, the gas-liquid separator 32, a depressurizing device 33, an evaporator 34, in which those components are connected in a closed fluid circuit.

The compressor device 3 is operatively connected with an engine 10 via a driving belt 4, a pulley 3a and an electromagnetic clutch 3b, and compresses refrigerant in the refrigerating cycle 30 to high temperature and high pressure refrigerant when it is driven by the engine 10. The condenser 31 is a heat exchanger for cooling down the high temperature and high pressure refrigerant to condense (liquidize) the refrigerant. A condenser fan 31a blows cooling air (outside air) toward the condenser 31. The gas-liquid separator 32 is a receiver for separating the refrigerant condensed at the condenser 31 into a gas-phase refrigerant and a liquid-phase refrigerant, to flow out the liquid-phase refrigerant.

The depressurizing device 33 is an expansion valve for depressurizing and expanding the liquid-phase refrigerant separated at the gas-liquid separator 32. The evaporator 34 is a heat exchanger for performing a heat absorbing operation by evaporating the refrigerant depressurized by the depressurizing device 33. The evaporator 34 is arranged in an A/C unit casing 30a. The evaporator 34 cools down air outside of a vehicle (the outside air) or air inside of the vehicle (the inside air), which is blown through the evaporator by a blower fan 34a.

The Rankine cycle 40 collects energy (a driving force generated at the expansion device 110) from waste heat generated at the engine 10. The condenser 31 and the gas-liquid separator 32 are commonly used in both of the refrigerating cycle 30 and the Rankine cycle 40. Namely, a first bypass passage 41 is provided, so that the gas-liquid separator 32 is connected to the condenser 31 through the refrigerant pump 130, a heating device 43, and the expansion device 110. Thus, the Rankine cycle 40 is formed.

The refrigerant pump 130 pumps out the refrigerant of the Rankine cycle 40 (the same to the refrigerant of the refrigerating cycle 30) to the heating device 43. Details of the pump 130 will be described below. The heating device 43 is a heat exchanger for heating the refrigerant by heat-exchange between the refrigerant supplied by the refrigerant pump 130 and engine cooling water (hot water) of an engine cooling circuit 20 (hot water circuit) of the engine 10.

An electrically operated water pump 22 for circulating the engine cooling water , a radiator 23 for heat-exchanging the engine cooling water with the outside air for cooling down the engine cooling water, and a heater core 24 for heating the air by the hot water from the engine are provided in the hot water circuit 20. A radiator bypass passage 23a is provided in the hot water circuit 20. A flow amount of the engine cooling water to the radiator 23 is adjusted by a thermostat 23b, a valve of which is opened and closed depending on the temperature of the engine cooling water.

The heater core 24 is also arranged in the A/C unit casing 30a together with the evaporator 34. The temperature of the air to be blown into the passenger room of the vehicle is controlled by the heater core 24 and the evaporator 34, so that the temperature is controlled at a temperature set by a passenger.

The expansion device 110 generates a rotational driving force by expanding the super heated refrigerant from the heating device 43. Detailed structure will be explained below. An electronic control device 15 is provided to control operations of the respective components of the refrigerating cycle 30 and the Rankine cycle 40.

The electronic control device 15 has an inverter 12 and an electronic control unit 14. The inverter 12 controls the operation of the motor generator 120. The inverter 12 controls the electric power to be supplied from a battery 13 of the vehicle to the motor generator 120 when it is operated as the electric motor, whereas the inverter 12 charges the electric power into the battery 13 when the motor generator 120 is operated as the electric power generator driven by the rotational force generated at the expansion device 110.

The electronic control unit 14 controls not only the operation of the inverter 12 but also the operations of the electromagnetic clutch 3b, the condenser fan 31a, the valve device 117 (the electromagnetic valve 117h in FIG. 10) and so on.

A structure of the fluid machine 100 will be explained with reference to FIG. 10. The expansion device 110, the motor generator 120 and the refrigerant pump 130 are coaxially arranged and integrally formed. The fluid machine 100 is generally installed in the vehicle such that its operating shaft is vertically arranged. Therefore, the expansion device 110, the motor generator 120 and the refrigerant pump 130 are arranged in this order from a bottom to a top of the fluid machine 100.

The expansion device 110 has the same structure to a well-known scroll type compressor, and comprises an expansion housing 111, which is composed of a front housing 111a, a shaft housing 111b, and a fixed scroll 112 provided between the front and shaft housings 111a and 111b. The expansion device 110 further comprises a movable scroll 113 facing to and rotated with respect to the fixed scroll 112, a communication port 116 for communicating a working chamber V with a high pressure chamber 114, and a valve device 117 for opening and closing the communication port 116.

The fixed scroll 112 has a base plate 112a and a vortical scroll wrap 112b extending from the base plate 112a toward the movable scroll 113, whereas the movable scroll 113 has a vortical scroll wrap 113b to be contacted and engaged with the vortical scroll wrap 112b and a base plate 113a on which the scroll wrap 113b is formed. The working chamber V is formed between the fixed scroll 112 and the movable scroll 113, the scroll wraps 112b and 113b of which are operatively contacted with each other. The volume of the working chamber V is changed (expanded or contracted) when the movable scroll 113 is rotated with respect to the fixed scroll 112 (moves around the fixed scroll).

A sliding plate 113d is disposed between the movable scroll 113 and the shaft housing 111b. The lubricant contained in the refrigerant is supplied to the sliding plate 113d to assure a smooth movement of the movable scroll 113. A shaft 118 is rotationally supported by a bearing 118b fixed to the shaft housing 111b.

The shaft 118 is a crank shaft having a crank portion 118a at its one axial end, wherein the crank portion 118a is eccentric with respect to a rotational center of the shaft 118. The crank portion 118a is operatively coupled to the movable scroll 113 via a bearing 113c. The crank portion 118a forms a part of the crank mechanism, such as the swing-ring type or the slider type crank mechanism described in the above first and second embodiments. The detail explanation thereof is omitted here.

A self rotation prevention mechanism 119 is provided between the movable scroll 113 and the shaft housing 111b, so that the movable scroll 113 rotates around the crank portion 118a by one turn when the shaft 118 is rotated by one turn. Namely, the movable scroll 113 is prevented from rotating on its axis but is rotated around the rotational center of the shaft 118 (in an orbital motion). The volume of the working chamber V becomes larger, as the working chamber is moved from its center toward the outside portion of the movable scroll 113 in accordance with the rotation of the shaft 118 (by the rotational force from the motor generator 120) and the expansion of the super heated refrigerant from the heating device 43.

An inlet port 115 is formed at a center portion of the base plate 112a, so that the working chamber V, which has become to its minimum volume, is communicated with the high pressure chamber 114 formed in the front housing 111a. The high temperature and high pressure refrigerant, i.e. the super heated refrigerant supplied to the high pressure chamber 114, is introduced into the working chamber V. A high pressure port 111c is provided in the front housing 111a for connecting the high pressure chamber 114 with the heating device 43.

A low pressure port 121a is formed at an upper portion (a side of the refrigerant pump 130) of a motor housing 121 for communicating the expansion device 110 with the condenser 31. The low pressure port 121a is communicated with a low pressure side (an outer peripheral portion of the fixed and movable scrolls 112 and 113) of the expansion device 110, through inside space of the motor housing 121.

The valve device 117 is a valve means for safely and surely stopping the operation of the expansion device 110. When an abnormal operation occurs in the Rankine cycle 40 (for example, an abnormal rotational speed of the motor generator 120, or a non-controllable condition of the motor generator 120), the expansion operation of the super heated refrigerant in the working chamber V is stopped by opening the communication port to forcibly communicate the low pressure side of the fixed and movable scrolls 112 and 113 with the high pressure chamber 114.

The valve device 117 has a valve body 117d which is biased toward the communication port 116 by a spring 117f disposed in a back pressure chamber 117e, an orifice 117g having a certain flow resistance and communicating the back pressure chamber 117e with the high pressure chamber 114, and an electromagnetic valve 117h for adjusting the pressure in the back pressure chamber 117e by opening and closing its valve portion to communicate the back pressure chamber 117e with the high pressure side or the low pressure side.

The electromagnetic valve 117h is operated by the electronic control unit 14. When the low pressure side of the electromagnetic valve 117h is opened, the pressure in the back pressure chamber 117e is decreased to become lower than that in the high pressure chamber 114. The valve body 117d is moved in a downward direction of FIG. 10, compressing the spring 117f, to open the communication port 116.

The motor generator 120 has a stator 122 and a rotor 123 rotating in the inside of the stator 122. The stator 122 and rotor 123 are accommodated in the motor housing 121 fixed to the shaft housing 111b. The stator 122 is a stator coil wound with electric wires and is fixed to an inner peripheral surface of the motor housing 121.

The rotor 123 is a magnet rotor, in which permanent magnets are provided, and is fixed to a motor shaft 124. One end of the motor shaft 124 is connected to the shaft 118 of the expansion device 110, and the other end is formed into a small diameter portion, which is operatively connected to a pump shaft 134 of the refrigerant pump 130, as described below.

At the start up period of the Rankine cycle 40, the motor generator 120 is operated as a motor (the electric motor) for driving the expansion device 110 as well as the refrigerant pump 130, when electric power is supplied from the battery 13 to the stator 122 through the inverter 12 to rotate the rotor 123.

The motor generator 120 is furthermore operated as a generator (an electric power generator) for generating electric power, when a torque for rotating the rotor 123 is inputted by a driving force generated by the expansion device 110 and when the rotational torque generated at the expansion device 110 becomes larger than the driving force for driving the refrigerant pump 130. The electric power thus obtained is charged into the battery 13 through the inverter 12.

The refrigerant pump 130 is a rolling-piston type pump arranged at a side of the motor generator 120 opposite to the expansion device 110. The refrigerant pump 130 is accommodated with in a space defined by a pump housing 131, and has a cylinder 136a, a rotor 138 and so on. The cylinder 136a is formed at a center portion of a cylinder block 136 and formed into a circular shape in a horizontal cross section.

The pump shaft 134 is connected to the motor shaft 124. In the embodiment shown in FIG. 10, the pump shaft 134 is formed as a part of the motor shaft 124. The pump shaft 134 is rotationally supported by bearings 134c and 134d fixed to side plates 137, which sandwich the cylinder block 136. An eccentric circular portion 134a is provided on the pump shaft 134, wherein the center axis of the circular portion 134a is eccentric to the center axis of the pump shaft 134. The rotor 138 of a ring shape is provided at an outer periphery of the eccentric circular portion 134a.

An outer diameter of the rotor 138 is designed smaller than an inner diameter of the cylinder 136a and arranged within the cylinder 136a. The rotor 138 moves around the pump shaft 134 within the cylinder because of the eccentric circular portion 134a. A vane 139 is slidably provided in the cylinder block 136, such that the vane 139 is biased toward the center of the rotor 138. The vane 139 slides in a radial direction and its forward end is brought into contact with the outer peripheral surface of the rotor 138. A pump chamber P is formed by a space defined by the rotor 138 and the vane 139 within the cylinder 136a.

A refrigerant inlet port 136b and a refrigerant outlet port (not shown) are formed in the side plate 137 adjacent to the vane 139, wherein the inlet and outlet ports are communicated with the inside space (the pump chamber P) of the cylinder 136a. The refrigerant inlet port 136b is connected with a suction port 131a which penetrates the pump housing 131. The refrigerant outlet port (not shown) is communicated with a high pressure space 131c, which is formed by the pump housing 131 and the cylinder block 136 (the side plate 137), via a discharge valve 136c.

The high pressure space 131c is communicated with a discharge port 131b, which is formed in a side wall portion of the pump housing 131 at such a portion close to the motor generator 120. The refrigerant is sucked into the pump chamber P from the suction port 131a and the refrigerant inlet port 136b, when the rotor 138 is rotated around the pump shaft 134. The refrigerant is then discharged from the discharge port 131b through the refrigerant outlet port (not shown), the discharge valve 136c and the high pressure space 131c.

A shaft passage 103 is formed in the inside of the shaft 118, the motor shaft 124 and the pump shaft 134, which are integrally formed. The shaft passage 103 axially extends from a lower end of the shaft 118 (the crank portion 118a) to the eccentric circular portion 134a. An upper end of the shaft passage 103 is opened at the outer peripheral surface of the eccentric circular portion 134a. An orifice 104 having a certain fluid resistance is provided in the shaft passage 103 at a portion adjacent to the outer peripheral surface of the eccentric circular portion 134a.

In the above fifth embodiment, the valve device 117 is provided in the expansion housing 111. Instead of such valve device 117, a bypass passage may be provided for bypassing the expansion device 110 and a valve identical or similar to the valve device 117 may be provided in the bypass passage.

(Further Modifications)

In the above fifth embodiment, the expansion device 110, the motor generator 120 and the refrigerant pump 130 are integrally formed into one unitary fluid machine 100. The present invention should not be limited to this embodiment. For example, the expansion device and the refrigerant pump may be separately formed and the expansion device and the motor generator may be integrally formed. Furthermore, the refrigerant pump 130 may be formed as a scroll type pump instead of the rolling-piston type pump.

### Sixth Embodiment

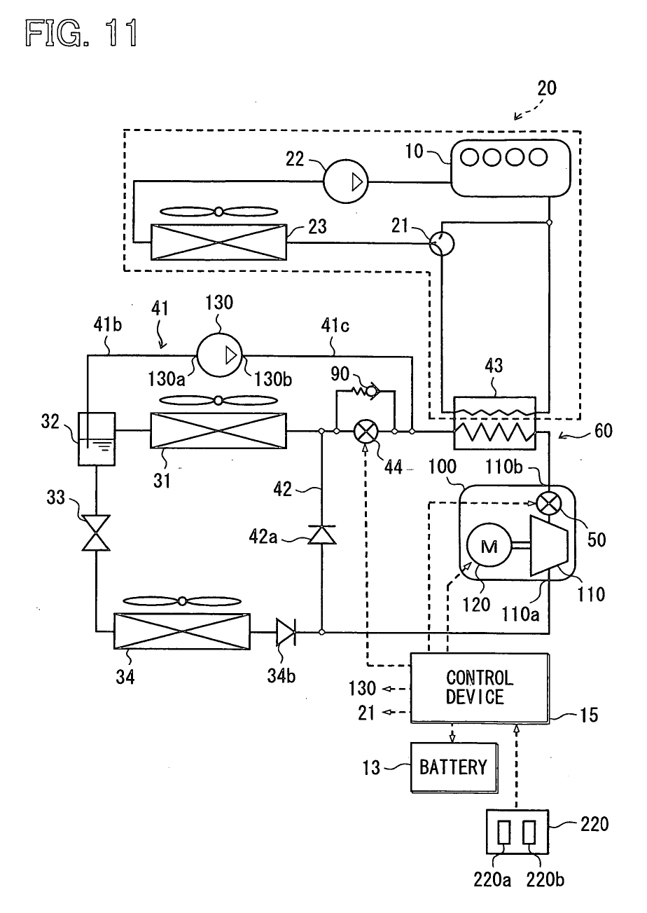

In a sixth embodiment, a heat cycle apparatus of the present invention is applied to an automotive gas compression refrigerating apparatus (a refrigerating cycle) having Rankine cycle. FIG. 11 is a schematic view showing a system structure. In the gas compression refrigerating apparatus, cold heat and hot heat are generated to perform an air conditioning operation in a passenger room of a vehicle, and energy is collected from waste heat generated at an automotive engine 10.

An expansion-compressor fluid machine 100 is operated as a compressor device, when the heat cycle apparatus is operated as a refrigerating cycle for performing the air conditioning operation for the vehicle passenger room (hereinafter also referred to as “an air conditioning mode”). The expansion-compressor fluid machine 100 is further operated as an expansion device, when the heat cycle apparatus is operated as Rankine cycle for collecting waste heat (hereinafter also referred to as “a waste heat collecting mode”). The expansion-compressor fluid machine 100 is a fluid machine capable of a reversible rotational operation.

The expansion-compressor fluid machine 100 is installed in an engine compartment of a vehicle, and has an expansion-compressor device 110, a motor generator 120 and a control valve 50, and so on.

The expansion-compressor device 110 has a function for compressing and pumping out refrigerant when a driving force is applied to the expansion-compressor device 110 in the air conditioning mode, and a function for generating mechanical energy (rotational force) by expansion of the refrigerant in the waste heat collecting mode. The expansion-compressor device 110 has the same structure to a well known scroll type compressor. A low pressure port 110a for sucking or discharging low pressure refrigerant, and a high pressure port 110b for pumping out or introducing high pressure refrigerant are provided in the expansion-compressor device 110.

The motor generator 120 has a function for applying a driving force to the expansion-compressor device 110 in the air conditioning mode, and a function for generating electric power by the mechanical energy produced at the expansion-compressor device 110 in the waste heat collecting mode. The motor generator 120 has the same structure of a well known direct current electric motor. A rotating shaft of the expansion-compressor device 110 and a rotating shaft of the motor generator 120 are coupled with each other, so that the expansion-compressor device 110 and the motor generator 120 can integrally operate.

The control valve 50 is provided on a side of the high pressure port 110b of the expansion-compressor device 110. The control valve 50 is an electromagnetic valve, which is operated as a discharge valve, namely a check valve, in the air conditioning mode, so that the control valve 50 allows the refrigerant to flow only from the expansion-compressor device 110 to a heating device 43 (described below). The control valve 50 is opened in the waste heat collecting mode. The control valve 50 operates as the check valve when no electric current is supplied thereto.

A high pressure pipe 60 forms a refrigerant passage for connecting the high pressure port blob of the expansion-compressor device 110 with an ON-OFF valve 44, which is an electromagnetic type valve for opening and closing the high pressure pipe 60. The ON-OFF valve 44 is closed when no electric current is supplied thereto. The ON-OFF valve 44 is further connected to a heat radiating device 31 (described below).

A relief valve 9 is provided in parallel with the ON-OFF valve 44 and bypasses the valve 44, so that the refrigerant flows from the high pressure pipe 60 to the heat radiating device 31 when the pressure in the high pressure pipe becomes higher than a predetermined pressure. A minimum value of a withstand pressure for the respective components of the heat cycle is 4.0 MPa in the embodiment. A preset value for the relief valve 9 is, therefore, set at 3.0 MPa. The above control valve 50, the ON-OFF valve 44 and the relief valve 9 forms a pressure maintaining device for maintaining the pressure of the refrigerant in the high pressure pipe (refrigerant pipe) 6 when the Rankine cycle is not in its operation.

The heat radiating device 31 (hereinafter also referred to as a condenser) is a heat exchanger for radiating heat of the refrigerant to outside air to cool down the refrigerant. A gas-liquid separator 32 is a receiver connected to a refrigerant outlet side of the condenser 31 for separating the refrigerant from the condenser 31 into a gas-phase refrigerant and a liquid-phase refrigerant. A first bypass passage 41 is a refrigerant pipe for supplying the liquid-phase refrigerant from the gas-liquid separator 32 to the high pressure port 110b of the expansion-compressor device 110.

A refrigerant pump 130 is a pump for pumping out the refrigerant from the gas-liquid separator 32 to the high pressure port 110b, and is installed in the engine compartment of the vehicle. The refrigerant pump 130 is also referred to as a refrigerant pressurizing device for pressurizing the refrigerant and supplying the pressurized refrigerant. A suction port 130a for sucking the refrigerant and a discharge port 130b for discharging the refrigerant are provided in the refrigerant pump 130.

The suction port 130a is connected to the gas-liquid separator 32 via an upstream portion 41b of the first bypass passage 41, whereas the discharge port 130b is connected to a juncture A between the ON-OFF valve 44 and the heating device 43 in the high pressure pipe 60 via a downstream portion 41c of the first bypass passage 41. The high pressure pipe 60 and the downstream portion 41c of the first bypass passage 41 form a refrigerant pipe for connecting the refrigerant pump 130 with the expansion device 3.

The refrigerant pump 130 allows to flow the refrigerant only from the suction port 130a to the discharge port 130b. The refrigerant pump 130 may be constructed by a well known scroll type pump driven by an electric motor. However, it may be alternatively a mechanical type pump driven by the engine 10 or the expansion-compressor device 110, or any other type of the pump.

An expansion valve 33 (also referred to as a depressurizing device) is connected to an outlet side for the liquid-phase refrigerant for depressurizing and expanding the liquid-phase refrigerant separated at the gas-liquid separator 32. A temperature dependent type expansion valve 33 is used in this embodiment, wherein an opening degree of the valve is controlled so that superheated degree of the refrigerant to be sucked into the low pressure port 110a of the fluid machine 100 (the expansion-compressor device 110) in the air conditioning mode is controlled at a predetermined value.

An evaporator 34 is connected to the expansion valve 33 and is a heat absorbing device for performing a heat absorbing operation by evaporating the refrigerant depressurized by the expansion valve 33. A refrigerant outlet side of the evaporator 34 is connected to the low pressure port 110a of the fluid machine 100 (the expansion-compressor device 110). A check valve 34b is provided in a refrigerant passage connecting the evaporator 34 to the fluid machine 100, wherein the check valve 34b allows the refrigerant to flow only from the evaporator 34 to the low pressure port 110a of the fluid machine 100 (the expansion-compressor device 110).

The heating device 43 is a heat exchanger provided in the high pressure pipe 60 between the high pressure port 110b and the juncture A for heating the refrigerant by heat-exchange between the refrigerant flowing through the high pressure pipe 60 and engine cooling water.

The engine cooling water is circulated in an engine cooling circuit 20 (hot water circuit) of the engine 10 as indicated by a dotted line in FIG. 11. A water pump 22 in the hot water circuit 20 is an electrically operated pump for circulating the engine cooling water.

A three way valve 21 is an electromagnetic valve for switching from a circuit mode (a hot water circulation position) for supplying the engine cooling water to the heating device 43 to another circuit mode (a hot water bypass position) for bypassing the heating device 43. When no electric current is supplied to the three way valve 21, the three way valve 21 is positioned in the hot water circulation position for supplying the engine cooling water to the heating device 43. A radiator 23 is a heat exchanger for heat-exchanging the engine cooling water with the outside air for cooling down the engine cooling water.

A second bypass passage 42 is a refrigerant passage for connecting the low pressure port 110a of the fluid machine 100 with a refrigerant inlet side of the condenser 31. A check valve 42a is provided in the second bypass passage 42 for allowing the refrigerant to flow only from the low pressure port 110a to the condenser 31.

A control device 15 is an electronic control unit for controlling operations of the components for the heat cycle. An operation switch panel 220 is provided at a front side of a vehicle passenger room adjacent to an instrument panel. The switch panel 220 has a switch 220a for an air conditioning operation and a switch 220b for a waste heat collecting operation. Control signals by the switches 220a and 220b are inputted to the electronic control unit 15.

When the switch 220a for the air conditioning operation is turned on, operation command signals for the air conditioning mode are inputted to the electronic control unit 15, and at the same time the switch 220b for the waste heat collecting operation is forcibly turned off. On the other hand, when the switch 220b for the waste heat collecting operation is turned on, operation command signals for the waste heat collecting mode are inputted to the electronic control unit 15, and at the same time the switch 220a for the air conditioning operation is forcibly turned off. As above, either one of the command signals for the air conditioning operation and for the waste heat collecting operation is allowed to be inputted to the electronic control unit 15.

The switch 220a for the air conditioning operation and the switch 220b for the waste heat collecting operation can be turned off at the same time, whereas either one of the switches 220a and 220b can be selectively turned on. As above, the air conditioning operation (the refrigerating cycle) and the waste heat collecting operation (the Rankine cycle) can be selectively switched over.

An output side of the electronic control unit 15 is connected to the motor generator 120, the control valve 50, the ON-OFF valve 44, the refrigerant pump 130, the three way valve 21 and a battery 13, so that those components are controlled by output signals from the electronic control unit 15.

An operation of the above embodiment will be explained. An operation of the gas compression refrigerating apparatus in case that both of the switches 220a and 220b are turned off, namely a condition of the apparatus which is not in an operation will be explained at first.

The motor generator 120 and the refrigerant pump 130 are not operated, no electric current is supplied to the control valve 50, the ON-OFF valve 44 and the three way valve 21, and the motor generator 120 is not electrically connected to the battery 13, during the non-operation of the gas compression refrigerating apparatus.

Therefore, the control valve 50 is operated as the check valve, and the ON-OFF valve 44 is closed. The inside of the high pressure pipe 60 and the inside of the downstream portion 41c of the first bypass passage 41 are formed as a closed space to keep the refrigerant pressure, because the refrigerant may not be allowed to flow from the discharge port 130b to the suction port 130a in the refrigerant pump 130.

Furthermore, since no electric current is supplied to the three way valve 21 during the non-operation of the gas compression refrigerating apparatus, the engine cooling water circuit is switched to the hot water circulation mode in which the engine cooling water can be supplied to the heating device 43. Accordingly, the engine cooling water (hot water) is circulated from and back to the water pump 22 through the engine 10, the heating device 43, the three way valve 21, and the radiator 23.

The above operation can be done because the engine cooling water is made to the hot water when the engine 10 is operated, even during the non-operation of the gas compression refrigerating apparatus, and this operation is done for the purpose of increasing the refrigerant pressure in the above described closed space (60 and 41c) by heating the refrigerant at the heating device 43. As a result, the smooth start-up operation of the Rankine cycle can be realized.

When the engine operation is stopped, the refrigerant pressure in the above closed space can not be increased even by making the engine cooling water to flow through the heating device 43. When the engine operation is stopped, there is no waste heat generated by the engine 10. Therefore, it is not necessary to operate the Rankine cycles Accordingly, there is no disadvantage even if the three way valve 21 is switched to the hot water circulation mode.

As above, the refrigerant pressure in the closed space (60, 41c) is increased, even during the non-operation of the gas compression refrigerating apparatus but so long as the engine operation is continued. However, the refrigerant pressure may not become higher than the predetermined value (3.0 MPa) because of the operation of the relief valve 90.

Since the preset relief pressure of the relief valve 90 is smaller than the minimum value (4.0 MPa) of the withstand pressure for the respective components (such as the control valve 50, the ON-OFF valve 44, the refrigerant pump 130) and refrigerant pipe connecting portions, to which the refrigerant pressure in the closed space is applied, the reliability of those components (100, 44, 130, 43) for the heat cycle can be assured.

An operation for the case, in which the switch 220a for the air conditioning mode is turned on and the air conditioning operation is required, will be explained. When the air conditioning operation is required, the electronic control unit 15 controls to operate the motor generator 120, opens the ON-OFF valve 44, and switches over to the hot water bypass position for bypassing the heating device 43. The electronic control unit 15 further controls such that no electric power is supplied to the control valve 50, and the refrigerant pump 130 is not operated.

When the electric power is supplied to the motor generator 120, a rotational driving force is transmitted to the expansion-compressor device 110 through the rotating shaft. The expansion-compressor device 110 then sucks the refrigerant from the low pressure port 110a, compresses the sucked refrigerant, and pumps out the compressed refrigerant from the high pressure port 110b. The pumped out refrigerant from the high pressure port 110b is supplied to the condenser 31 through the heating device 43 and the ON-OFF valve 44.

In the air conditioning mode, since the ON-OFF valve 44 is opened and the three way valve 21 is switched to the hot water bypass position, the engine cooling water in the hot water circuit is circulated from and back to the water pump 22, the engine 10, the three way valve 21, and the radiator 23, so that the engine cooling water bypasses the heating device 43.

Accordingly, the refrigerant is not heated at the heating device 43, wherein the heating device 43 and the ON-OFF valve 44 work here simply as a part of the refrigerant passage. Furthermore, in the air conditioning mode, since a sufficient flow passage area is assured at the ON-OFF valve 44, no pressure difference appears between the upstream and downstream sides of the relief valve 90. The relief valve 90 is, therefore, not opened.

The refrigerant radiates the heat at the condenser 31, and separated into the gas-phase and liquid-phase refrigerant in the gas-liquid separator 32. Since the refrigerant pump 130 is not operated, the liquid-phase refrigerant is not sucked into the refrigerant pump 130. The liquid-phase refrigerant separated in the gas-liquid separator 32 is depressurized at the expansion valve 33, absorbs the heat at the evaporator 34, and sucked into the expansion-compressor device 110 through the low pressure port 110a.

Accordingly, the refrigerating cycle is formed in the air conditioning mode, in which the refrigerant is circulated from and back to the expansion-compressor device 110 through the condenser 31, the gas-liquid separator 32, the expansion valve 33, and the evaporator 34. The air conditioning operation for the vehicle passenger room is thus performed.

An operation for start-up of the air conditioning mode will be explained. At the start-up of the air conditioning mode, the ON-OFF valve 44 is opened, so that the refrigerant contained in the closed space formed by the high pressure pipe 60 and the downstream portion 41c of the first bypass passage 41 flows out to the condenser 31. The refrigerant pressure at the high pressure port 110b is thereby decreased. The operation of the expansion-compressor device 110 may not be adversely affected by the refrigerant pressure at the high pressure port 110b. The starting time for the expansion-compressor device 110 may be delayed with respect to the opening time of the ON-OFF valve 44, so that the refrigerant pressure at the high pressure port 110b is sufficiently decreased.

An operation for the case, in which the switch 220b for the waste heat collecting mode is turned on and the waste heat collecting operation is required, will be explained. When the waste heat collecting operation is required, the electronic control unit 15 controls to open the control valve 50, to close the ON-OFF valve 44, and to operate the refrigerant pump 130. The electronic control unit 15 further controls the three way valve 21 to switch over to the hot water circulation position for supplying the hot water to the heating device 43. The motor generator 120 is controlled to be operated as the electric power generator and is electrically connected to the battery 13.

When the three way valve 21 is switched over to its hot water circulation position, the hot water is circulated through the heating device 43 so that the refrigerant in the high pressure pipe 60 is heated by the waste heat from the engine 10. In the waste heat collecting mode, since the ON-OFF valve 44 is closed, the heated refrigerant is supplied from the heating device 43 to the expansion-compressor device 110 through the control valve 50. The refrigerant introduced into the expansion-compressor device 110 is expanded to rotate the rotating shaft and flows out from the low pressure port 110a.

The motor generator 120 is rotated together with the rotation of the rotating shaft of the expansion-compressor device 110, so that the motor generator 120 is operated as the electric power generator. The electric power thus generated is charged into the battery 13 through the control device 15.

As above, the refrigerant is expanded by use of the waste heat from the engine 10, the mechanical energy (the rotating force) is thereby generated at the expansion-compressor device 110, and the mechanical energy is converted into the electric energy at the motor generator 120. The heat energy (the waste heat) is thus collected.

In the above embodiment, the heated and pressurized refrigerant flows from the high pressure port 110b to the low pressure port 110a. The refrigerating apparatus of the embodiment is so designed that the refrigerant pressure at the high pressure port 110b may not exceed a predetermined value (e.g. 2.5 MPa). The relief valve 90 is, therefore, not opened during the waste heat collecting mode.

The refrigerant from the low pressure port 110a is introduced into the heat radiating device (the condenser) 31 through the second bypass passage 42, because of the function of the check valve 34b. The refrigerant, heat of which is radiated at the heat radiating device (the condenser) 31, flows into the gas-liquid separator 32 in which it is separated into the gas-phase and the liquid-phase refrigerant. The liquid-phase refrigerant separated at the gas-liquid separator 32 is sucked by the refrigerant pump 130 and pumped out to the heating device 43.

As above, the Rankine cycle is formed in the waste heat collecting mode, in which the refrigerant is circulated from and back to the refrigerant pump 130 through the heating device 43, the expansion-compressor device 110, the second bypass passage 42, the condenser 31, the gas-liquid separator 32, and the first bypass passage 41. The energy is thus collected from the waste heat of the engine 10.

An operation for start-up of the waste heat collecting mode will be explained. At the start-up of the waste heat collecting mode, since the refrigerant in the closed space formed by the high pressure pipe 60 and the downstream portion 41c of the first bypass passage 41 is maintained at the high pressure, the high pressure and high temperature refrigerant is introduced into the expansion-compressor device 110 through the high pressure port 110b immediately when the control valve 50 is opened. The mechanical energy can be, therefore, quickly obtained at the expansion-compressor device 110. Thus, the start-up performance of the Rankine cycle is improved.

In the above embodiment, the reliability of the respective components for the refrigerating cycle and the Rankine cycle can be assured, and at the same time the start-up performance of the Rankine cycle is enhanced.

### Seventh & Eighth Embodiments

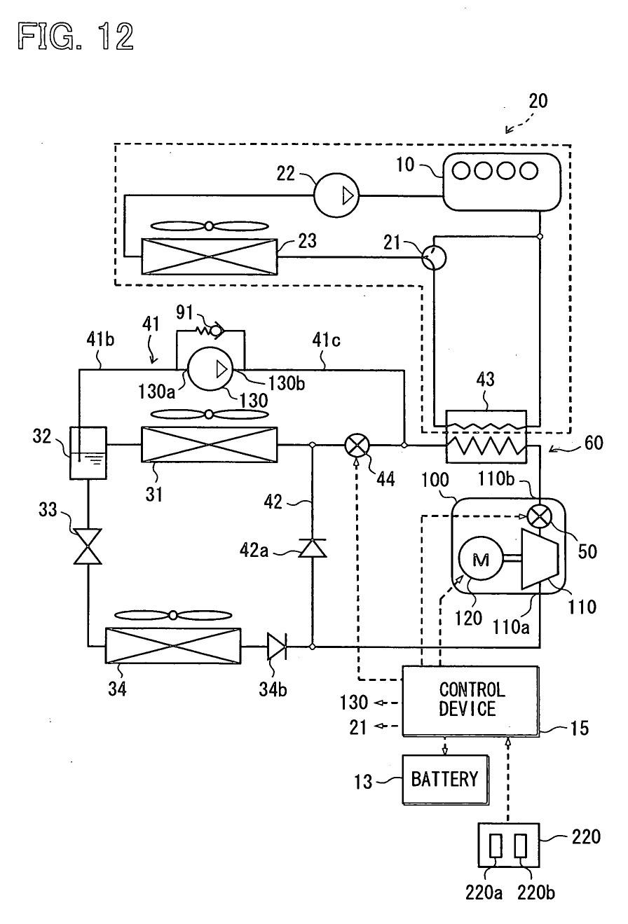

In the above sixth embodiment, the relief valve 90 is provided in parallel with the ON-OFF valve 44. According to a seventh embodiment, however, a relief valve 91 may be provided in the first bypass passage 41 in parallel with the refrigerant pump 130, as shown in FIG. 12. In such a modification, the refrigerant flows from the downstream portion 41c to the upstream portion 41b, when the refrigerant pressure in the high pressure pipe 60 becomes higher than the predetermined value and the relief valve 91 is opened.

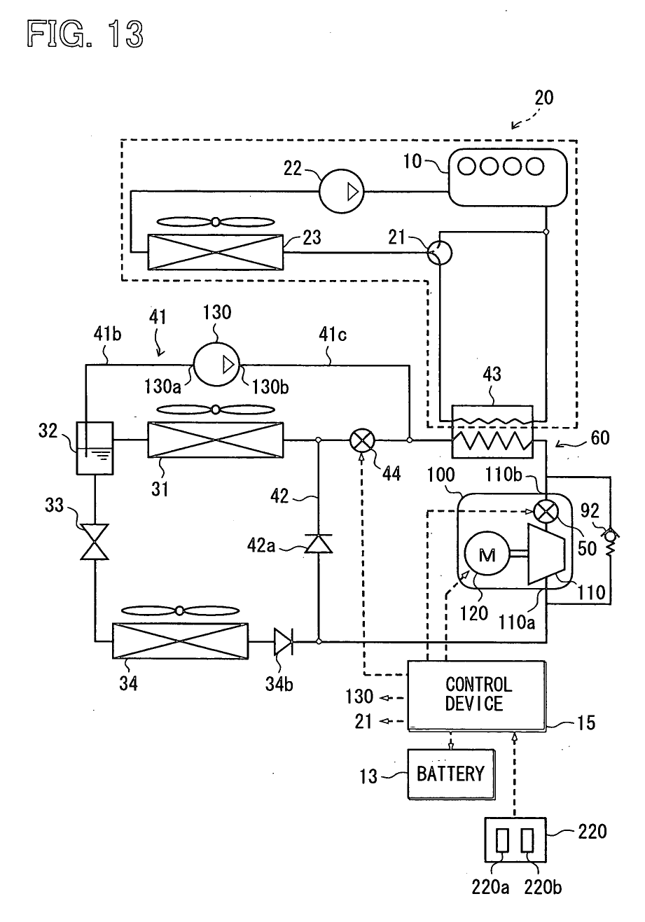

According to an eighth embodiment, a relief valve 92 may be provided in parallel with the expansion-compressor device 110, namely between the high pressure port 110b and the low pressure port 110a of the expansion-compressor device 110, as shown in FIG. 13. In such a modification, the refrigerant flows from the high pressure pipe 60 to the low pressure side (110a) when the refrigerant pressure in the high pressure pipe 60 becomes higher than the predetermined value and the relief valve 92 is opened.

With the above second and eighth embodiments, the same effect to the sixth embodiment can be achieved.

### Ninth Embodiment

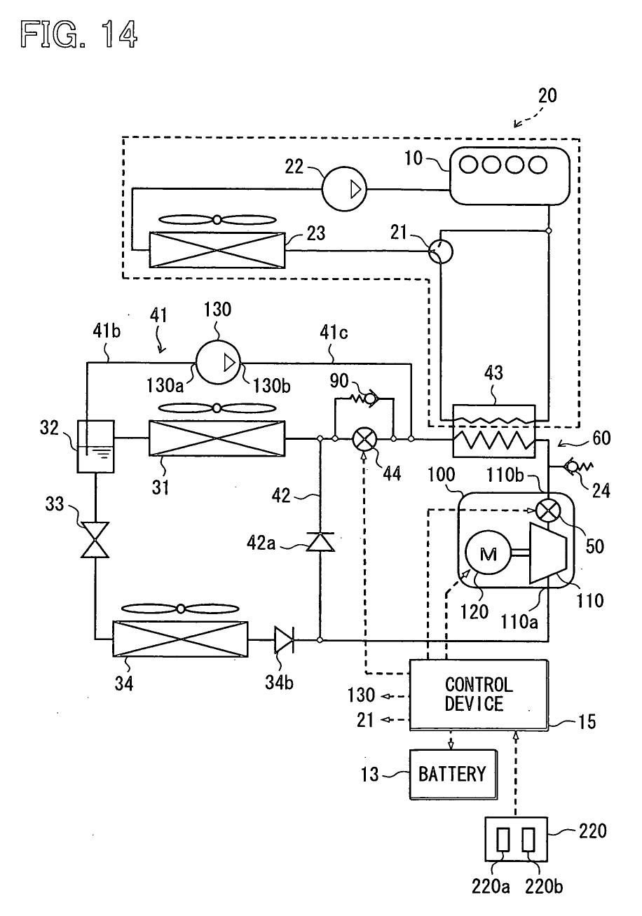

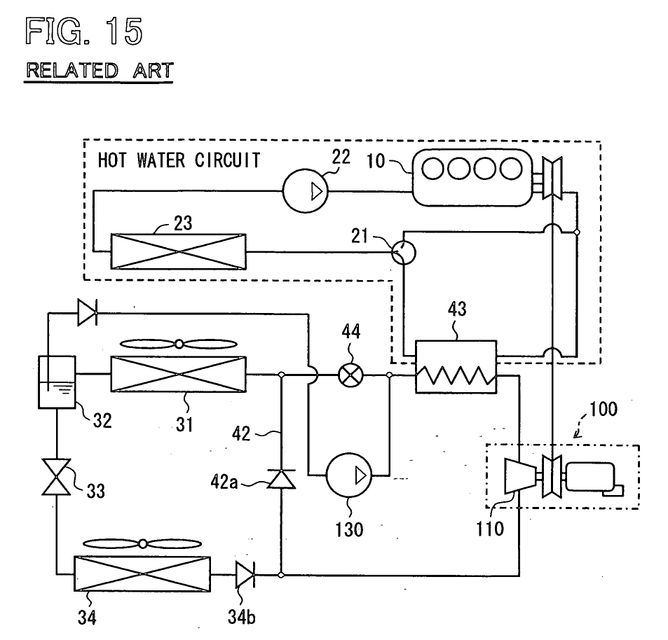

According to a ninth embodiment, a safety valve 240 is provided in addition to the relief valve 90, in order that a part of the refrigerant is discharged from the gas compression refrigerating apparatus to the outside thereof, when the refrigerant pressure in the closed space (60, 41c) becomes higher than a predetermined value. The safety valve 240 is provided in the high pressure pipe 60 between the heating device 43 and the high pressure port 110b, as shown in FIG. 14.

A preset opening pressure of the safety valve 240 is selected at such a value, which is lower than the minimum value of the withstand pressure of the respective components for the heat cycle, but which is higher than the preset value for the relief valve 90. The preset opening pressure of the safety valve 240 is, for example, selected at 3.5 MPa. The other structure of the ninth embodiment is the same to the sixth embodiment.

According to the above structure, the relief valve 90 is opened before the safety valve 240 is opened and the part of the refrigerant is discharged out of the refrigerating apparatus, in which the refrigerating apparatus may result in incapability of the normal operation. Thus, the same effect to the sixth embodiment can be achieved in the ninth embodiment.

### Other Embodiments

(1) In the above sixth to ninth embodiments, the driving force to the expansion-compressor device 110 is given by the motor generator 120, when the expansion-compressor device 110 is operated as the compressor device. The driving force may be applied to the expansion-compressor device 110 from the engine 10 via an electromagnetic clutch, a belt and so on.

(2) In the above sixth to ninth embodiments, the pressure maintaining means is constructed by the control valve 50, the ON-OFF valve 44 and the relief valve 90 (91, 92). The pressure maintaining means may be constructed by the control valve 50 and the ON-OFF valve 44 without using the relief valve 90.

For example, the relief valve 90 in the sixth embodiment maybe eliminated, and instead a pressure detecting device is provided for detecting the refrigerant pressure in the closed space formed by the high pressure pipe 60 and the downstream portion 41c of the first bypass passage 41. A detected refrigerant pressure is inputted to the control device 15. The other structure is the same to that of the sixth embodiments

During the gas compression refrigerating apparatus is not operated, the ON-OFF valve 44 is closed by the control device 15 when the detected refrigerant pressure from the pressure detecting device is lower than a predetermined value, whereas the ON-OFF valve 44 is opened when the detected refrigerant pressure is higher than the predetermined value. With such a structure, the refrigerant can be released from the closed space to the low pressure side, even in the case that the relief valve 90 is eliminated.

A flow amount adjusting valve may be used in place of the electromagnetic ON-OFF valve 44, wherein an valve opening degree is adjusted by a motor operation or an electromagnetic operation. In such a case, during the gas compression refrigerating apparatus is not operated, the flow amount adjusting valve is closed by the control device 15 when the detected refrigerant pressure from the pressure detecting device is lower than the predetermined value, whereas the opening degree of the flow amount adjusting valve is increased when the detected refrigerant pressure is higher than the predetermined value. With such a modification, the high pressure of the refrigerant in the closed space can be more precisely controlled and maintained.

(3) In the above embodiments, the three way valve 21 is switched over to the hot water circulation position so that the hot water is circulated through the heating device 43, when the gas compression refrigerating apparatus is not operated. A pressure detecting device may be provided to detect the refrigerant pressure in the closed space defined by the high pressure pipe 60 and the downstream portion 41c. And the three way valve 21 may be switched over to the hot water bypassing position, when the detected refrigerant pressure is higher than the predetermined value, even in the period that gas compression refrigerating apparatus is not operated.

According to such a modified embodiment, the refrigerant pressure in the closed space of the high pressure pipe 60 and the downstream portion 41c can be prevented from increasing to a higher value which is not wanted and necessary. With such a structure, the amount of the refrigerant released from the closed space can be made smaller, and thereby the start-up performance of the Rankine cycle can be further increased.

(4) In the above embodiment, the collected energy is charged into the battery. However, the collected energy may be charged as mechanical energy, such as a kinetic energy in a flywheel, or an elastic potential energy in a spring.

(5) In the above embodiments, the scroll type pump mechanism is applied to the expansion-compressor device 110. However, any other types of the pumps, such as the rotary type, piston type, vane type and the like may be used.

(6) In the above embodiments, the high pressure refrigerant is released through the relief valve 90 to the low pressure side, such as the juncture between the ON-OFF valve 44 and the condenser 31, the refrigerant suction port 130a of the refrigerant pump 130, the low pressure port 111a of the expansion-compressor device 110. An accumulator may be provided as a component for forming the low pressure side, to which the high pressure refrigerant may be released from the closed space.

(7) In the above embodiments, the ON-OFF valve 44, the relief valve 90 (91, 92) and the check valve 42a are formed as independent components. Those components, however, may be housed in a common valve housing to make them smaller in size.

(8) In the above embodiments, the switches 220a and 220b for the air conditioning mode and waste heat collecting mode are manually operated. The switch 220b for the waste heat collecting mode may be eliminated, and the switching over from the air conditioning mode to the waste heat collecting mode, and vice versa may be achieved by the single switch 220a.

For example, the switch 220b for the waste heat collecting mode is eliminated from the sixth embodiment, and a temperature detecting device is provided for detecting temperature of the engine cooling water in the hot water circuit 20. A detected temperature of the engine cooling water is inputted to the control device 15. The other structure is the same to that of the sixth embodiment.

When the switch 220a is turned on and the air conditioning operation is required, the control device 15 controls the related components of the refrigerating cycle to perform the air conditioning operation. On the other hand, when the switch 220a is turned off, and the control device 15 determines that the temperature of the engine cooling water reaches such a temperature, at which the refrigerant can be heated and pressurized, the control device 15 automatically starts the operation of the waste heat collecting operation.

As above, the air conditioning mode and the waste heat collecting mode can be switched over from one to the other by the single switch 220a for the air conditioning mode.

(9) In the above embodiments, the heating device 43 is operated with use of the waste heat from the engine 10. However, the heating device 43 may be operated with use of the waste heat from fuel cell, in case of a fuel-cell car.

(10) In the above ninth embodiment, the safety valve 240 is added to the sixth embodiment. However, the safety valve 240 may be likewise added to the seventh and eighth embodiments.

(11) The present invention is not limited to the use for the automotive vehicle. The present invention is not limited to the embodiments described above.

What is claimed is:

1. A fluid machine comprising:
a housing for accommodating an expansion device;
a shaft rotationally supported by the housing and having a driving pin at one axial end of the shaft, the driving pin being eccentric to a rotating center of the shaft;
a bushing having a hole for receiving therein the driving pin;
a movable scroll having a base plate provided with a boss portion for rotatably receiving the bushing, the movable scroll further having a vortical movable scroll wrap,
the movable scroll being operatively coupled with the shaft via a crank mechanism being composed of the driving pin, the bushing and the boss portion, so that the movable scroll is rotated around the shaft;
a fixed scroll fixed to the housing and having a base plate and a vortical fixed scroll wrap to be engaged with the vortical movable scroll wrap; and
a motor generator coupled to and operated with the shaft,
wherein a biasing member is provided for biasing the crank mechanism in a direction that the movable scroll wrap is separated from a contact in a circumferential direction with the fixed scroll wrap.

2. A fluid machine according to claim 1, wherein
the biasing member is an elastic member provided between the driving pin and the bushing.

3. A fluid machine according to claim 2, wherein the elastic member is made of rubber.

4. A fluid machine according to claim 3, wherein the elastic member is made of an O-ring of the rubber.

5. A fluid machine according to claim 2, wherein the elastic member is made of a spring.

6. A fluid machine according to claim 5, wherein a spring stopper is provided for retaining the spring.

7. A fluid machine according to claim 5, wherein a sliding member is provided between the driving pin and the spring.

8. A fluid machine comprising:
a housing for accommodating an expansion device;
a shaft rotationally supported by the housing and having a driving pin at one axial end of the shaft, the driving pin being eccentric to a rotating center of the shaft;
a movable scroll having a base plate provided with a boss portion for rotatably receiving the driving pin, the movable scroll further having a vortical movable scroll wrap,
the movable scroll being operatively coupled with the shaft via the driving pin and the boss portion, so that the movable scroll is rotated around the shaft;
a fixed scroll fixed to the housing and having a base plate and a vortical fixed scroll wrap to be engaged with the vortical movable scroll wrap; and
a motor generator coupled to and operated with the shaft, wherein a first clearance portion is provided on at least one of the movable and fixed scroll wraps at a center portion thereof to form a first clearance between them, a second clearance portion is provided on at least one of the movable and fixed scroll wraps at an outer portion thereof to form a second clearance between them, and a phase angle of a non-clearance portion formed between the first and second clearance portions is less than 360 degrees, and
a bypass mechanism is provided for communicating the center portion with a working chamber reaching its minimum volume.

9. A fluid machine according to claim 8, wherein the bypass mechanism comprises a check valve.

10. A fluid machine comprising:
a housing for accommodating an expansion device;
a shaft rotationally supported by the housing and having a driving pin at one axial end of the shaft, the driving pin being eccentric to a rotating center of the shaft;
a movable scroll having a base plate provided with a boss portion for rotatably receiving the driving pin, the movable scroll further having a vortical movable scroll wrap,
the movable scroll being operatively coupled with the shaft via the driving pin and the boss portion, so that the movable scroll is rotated around the shaft;
a fixed scroll fixed to the housing and having a base plate and a vortical fixed scroll wrap to be engaged with the vortical movable scroll wrap; and
a motor generator coupled to and operated with the shaft, wherein a clutch device is provided between the motor generator and the shaft for selectively connecting the motor generator with the shaft.

11. A fluid machine according to claim 10, wherein
the clutch device is a one way clutch,
the one way clutch is engaged to connect the motor generator with the expansion device, so that a driving force is transmitted from the motor generator to the expansion device, when the motor generator is rotated in one direction that volume of a working chamber formed by the movable and fixed scrolls is reduced,
the one way clutch is further engaged to connect the expansion device with the motor generator, so that a rotational force is transmitted from the expansion device to the motor generator, when the expansion device is rotated in the opposite direction that the volume of the working chamber formed by the movable and fixed scrolls is increased, and
the one way clutch is disengaged to disconnect the motor generator from the expansion device, when the motor generator is rotated in the opposite direction that the volume of the working chamber formed by the movable and fixed scrolls is increased.

12. A fluid machine according to claim 10, wherein
the expansion device has a function of a compressor device.

13. A heat cycle apparatus having Rankine cycle for converting heat energy contained in refrigerant into kinetic energy comprising:
a refrigerant pressurizing device for pressurizing refrigerant and supplying the pressurized refrigerant;
an expansion device for producing kinetic energy by expansion of the refrigerant from the refrigerant pressurizing device;
a refrigerant pipe for connecting the refrigerant pressurizing device with the expansion device;
a heating device for heating the refrigerant in the refrigerant pipe; and
a pressure maintaining device for maintaining the pressure of the refrigerant in the refrigerant pipe when the Rankine cycle is not in its operation,
wherein the pressure maintaining device releases a part of the refrigerant from the refrigerant pipe to a low pressure portion at which the pressure of the refrigerant is lower than that of the refrigerant in the refrigerant pipe, when the pressure of the refrigerant in the refrigerant pipe becomes higher than a predetermined value.

14. A heat cycle apparatus according to claim 13, wherein
the pressure maintaining device comprises an electrically operated control valve for opening and closing the refrigerant pipe, and a relief valve for releasing the part of the refrigerant from the refrigerant pipe to the low pressure portion,
the electrically operated control valve is closed when the Rankine cycle is not in its operation, and
the relief valve is opened when the pressure of the refrigerant in the refrigerant pipe becomes higher than the predetermined value.

15. A heat cycle apparatus according to claim 13, further comprising:
a pressure detecting device for detecting the pressure of the refrigerant in the refrigerant pipe,
wherein the pressure maintaining device is composed of an electrically operated control valve for opening and closing the refrigerant pipe, and
the electrically operated control valve is closed in case that the pressure detected by the pressure detecting device is lower than the predetermined value, and is opened in case that the pressure detected by the pressure detecting device is higher than the predetermined value, when the Rankine cycle is not in its operation.

16. A heat cycle apparatus according to claim 13, wherein
the low pressure portion is a refrigerant outlet port of the expansion device.

17. A heat cycle apparatus according to claim 13, wherein
the low pressure portion is a refrigerant suction port of the refrigerant pump.

18. A heat cycle apparatus according to claim 13, further comprising:
a safety valve for discharging a part of the refrigerant to an outside of the heat cycle apparatus when the pressure of the refrigerant in the heat cycle is higher than a preset pressure,
wherein the predetermined value for the pressure maintaining device is lower than the preset pressure for the safety valve.

19. A heat cycle apparatus according to claim 13, further comprising:
a refrigerating cycle for absorbing heat from a low temperature side by evaporating the low pressure refrigerant, compressing the evaporated gas-phase refrigerant to increase temperature of the refrigerant, and radiating the heat absorbed from the low temperature side to a high temperature side,
wherein an operational mode for the Rankine cycle and an operational mode for the refrigerating cycle are switched over from one to the other.

20. A gas compression refrigerating apparatus for a vehicle comprising:
a refrigerating cycle having a compressor device driven by an engine of the vehicle, a condenser, a gas-liquid separator, and an evaporator;
Rankine cycle having an expansion device, the condenser, the gas-liquid separator, a refrigerant pump, and a heating device; and
a fluid machine having the expansion device, a motor generator and the refrigerant pump,
wherein the fluid machine comprises:
a housing for accommodating the expansion device;
a fixed scroll fixed to the housing and having a base plate and a vortical fixed scroll wrap;
a movable scroll having a base plate and a vortical movable scroll wrap to be engaged with the fixed scroll wrap to form a working chamber;
a high pressure chamber defined by the housing and the base plate of the fixed scroll;
an inlet port formed at a center portion of the base plate of the fixed scroll, so that the inlet port communicates the high pressure chamber with the working chamber;
a communication port formed in the base plate of the fixed scroll for operatively communicating the working chamber formed at an outer portion of the of the fixed scroll wrap; and
a valve device having a valve body biased toward an opening end of the communication port opening to the high pressure chamber,
wherein the valve device opens the communication port when an abnormal operation occurs in the Rankine cycle, in order to safely and surely stop the operation of the expansion device.
